(19) United States
(12) Patent Application Publication
(10) Pub. No.: US 2026/0065390 A1
(43) Pub. Date: Mar. 5, 2026

(54) Automated Tool For Determining And Using Dwelling-Specific Predicted User Responses To Dwelling Description Information

(71) Applicant: MFTB Holdco, Inc., Seattle, WA (US)

(72) Inventors: Reid Kay, St. Augustine, FL (US); Winson Weifeng Quock, San Ramon, CA (US); Andy Lee Krause, Seattle, WA (US); Andrew Martin, Seattle, WA (US); Aaron Michael Dickinson, Las Vegas, NV (US); Emily Catherine Gill, Englewood, CO (US)

(21) Appl. No.: 18/788,017

(22) Filed: Jul. 29, 2024

(51) Int. Cl. G06Q 50/163; G06N 20/00

(52) U.S. Cl. CPC G06Q 50/163; G06N 20/00

(57) ABSTRACT

Techniques are described for performing automated operations related to determining and using information about one or more user-specific predicted attributes of dwellings that users will occupy in the future. The described techniques may include generating one or more predictive models trained to provide information about one or more target dwelling attributes of interest, such as to analyze training data about interactions of one or more types by a plurality of users with a plurality of dwellings before those users select a final dwelling to acquire and/or occupy, and to generate and train the predictive model(s) based on the training data to predict a value of each of the one or more target dwelling attributes for a target dwelling that a user will later acquire and/or occupy, and may further include using predicted target dwelling attribute values to provide dwelling-related information to one or more other users.

### TECHNICAL FIELD

The following disclosure relates generally to techniques for automatically determining and using information about dwelling-specific predicted user responses to dwelling description information for a target dwelling, such as to automatically determine and implement one or more modifications to an existing target dwelling description that is available to end users based on predicted resulting changes in end user interactions of one or more types with the target dwelling.

### BACKGROUND

An abundance of information is available to users on a wide variety of topics from a variety of sources. For example, portions of the World Wide Web (“the Web”) are akin to an electronic library of documents and other data resources distributed over the Internet, with billions of documents available, including groups of documents directed to various specific topic areas (e.g., buildings of various types). In addition, various other information is available via other communication mediums. However, existing search engines and other techniques for identifying information of interest suffer from various problems. Non-exclusive examples include a difficulty in understanding natural language requests, difficulty in providing accurate information that is specific to a particular topic of interest and/or useful to a particular user, difficulty in limiting information requests to approved topics, etc.

### BRIEF DESCRIPTION OF THE DRAWINGS

FIGS. 1A-1C are network diagrams illustrating an example system for performing described techniques, including automatically determining and using dwelling-specific predicted user responses to dwelling description information for a target dwelling.

FIG. 1D illustrates examples of non-exclusive types of dwelling description information.

FIGS. 2A-2E illustrate examples of performing described techniques, including automatically determining and using dwelling-specific predicted user responses to dwelling description information for a target dwelling.

FIG. 3 is a block diagram illustrating an example of a computing system for use in performing described techniques, including automatically determining and using dwelling-specific predicted user responses to dwelling description information for a target dwelling.

FIG. 4 illustrates a flow diagram of an example embodiment of an Automated Dwelling-Specific Description Modifier (“ADSDM”) system routine.

FIG. 5 illustrates a flow diagram of an example embodiment of an ADSDM Dwelling Description/User Action Prediction Trainer component routine.

FIG. 6 illustrates a flow diagram of an example embodiment of an ADSDM Dwelling-Specific Description Modification Predictor component routine.

FIG. 7 illustrates a flow diagram of an example embodiment of an ADSDM Dwelling-Specific Description Modification Information Selector/Provider component routine

FIG. 8 illustrates a flow diagram of an example embodiment of a client device routine.

### DETAILED DESCRIPTION

The present disclosure describes techniques for using computing devices to perform automated operations involving automatically determining and using information about dwelling-specific predicted user responses to dwelling description information for a target dwelling, such as in at least some embodiments to, for a target dwelling (e.g., house, home, apartment, condominium, short-term rental, other building, etc.) that is available for acquisition and/or occupancy (e.g., purchase, rental, etc.), automatically determine and implement one or more modifications to a description of the target dwelling that is available to end users (e.g., potential renters or other acquirers) based on predicted resulting changes in end user interactions of one or more types with the target dwelling resulting from the description modification(s). In at least some embodiments, the described techniques include generating one or more predictive models trained to provide predictions for future user responses based on particular types of information that are available to end users in a description of a target dwelling available for acquisition and/or occupancy (referred to generally herein as a ‘dwelling occupancy description’), such as to analyze training data about interactions of one or more types by a plurality of users with a plurality of dwellings available for acquiring or otherwise occupying and that have a plurality of types of associated dwelling occupancy description information, and to generate and train the predictive model(s) based on the training data to predict end user future interaction values or other future user responses for dwellings having those particular types of information—the generation and training of the predictive model(s) may be performed in various manners, as discussed further below. The trained predictive model(s) may be used to automatically assist in determining and implementing modifications to dwelling occupancy descriptions of target dwellings, such as by automatically implementing and/or proposing dwelling occupancy description modifications that are identified based on predicted resulting changes in end user future interactions or other future responses of one or more types with the associated dwellings in response to viewing or otherwise receiving the modified dwelling occupancy descriptions—the trained predictive model(s) may be used in various manners, as discussed further below. Additional details are included below regarding automatically determining and using information about dwelling-specific predicted user responses to dwelling occupancy description information for a target dwelling, and some or all of the techniques described herein may, in at least some embodiments, be performed via automated operations of an Automated Dwelling-Specific Description Modifier (“ADSDM”) system, as discussed further below.

As noted above, the automated operations of the ADSDM system in at least some embodiments include automatically determining and implementing one or more modifications to a target dwelling's dwelling occupancy description that is available to end users. A dwelling occupancy description may include various types of information about a target dwelling, and the ADSDM system may propose and/or implement a variety of types of modifications to such a dwelling occupancy description in various manners in various embodiments. As non-exclusive examples, a dwelling occupancy description may include one or more of the following: an overview textual description of a dwelling, such as with one or more sentences providing overview information about aspects of the dwelling, and/or of an associated property on which the dwelling is located, and/or of an associated neighborhood or area around the dwelling; a variety of dwelling attributes, optionally each including one or more values (e.g., attribute-value pairs), such as to each describe a feature of the dwelling and/or of occupancy rules associated with the dwelling; one or more images or other media items with content about the dwelling (e.g., one or more images with visual data of an interior of the dwelling; one or more images with visual data of an exterior of the dwelling, such as a street-level-view image of the front of the dwelling, an overhead image of some or all of the dwelling and optionally some or all of a surrounding property, etc.; one or more audio clips with audio data for the dwelling, such as audio captured at the dwelling and/or with content describing the dwelling; one or more videos with visual and optionally audio data for the dwelling; a two-dimensional, or 2D, floor plan of the dwelling; a three-dimensional, or 3D, computer model floor plan of the dwelling; a virtual tour of inter-linked images through which a viewer may progress in a user-selected and/or automated manner; etc.), user-generated content for the dwelling, such as user reviews and comments; etc. The dwelling attributes included in a dwelling occupancy description for a dwelling may be of various types in various embodiments, such as any quantifiable information about the dwelling, with non-exclusive examples including the following: quantity of bedrooms, quantity of bathrooms, square footage of the dwelling, square footage of the property on which the dwelling is located, quantity of garage spaces, quantity of parking spaces, school district, HOA fees, listing price, purchase price, price per dwelling square foot, pool or not, water view or not, pets allowed or not, etc., including information that is included in an MLS (multiple listing service) listing, as well as additional information that is derivable from other quantifiable information (e.g., distance to one or more specified types of services or amenities, such as a hospital, grocery store, park, etc.; estimated total monthly payments to finance a purchase with a specified down payment, such as to include a mortgage for the listing or purchase price along with estimates of other fees such as taxes, insurance, HOA fees, etc.; estimated total monthly payments to rent, such as to include estimates of other fees such as utilities and insurance; etc.).

Similarly, proposed and/or implemented modifications to a dwelling occupancy description may be of various types in various embodiments, with non-exclusive examples including the following: a change to one or more values of an existing dwelling attribute in the dwelling occupancy description; to add a new dwelling attribute and optionally associated value(s) to the dwelling occupancy description; to remove an existing dwelling attribute and optionally associated value(s) from the dwelling occupancy description; a list of dwelling attributes and optionally associated values to use in a dwelling occupancy description (e.g., as part of generating a new dwelling occupancy description), such as generated based on existing dwelling attributes and associated values or otherwise generated from other available information about the dwelling; a change to an existing overview textual description in the dwelling occupancy description, such as to add information of one or more indicated types and/or to remove indicated information; a partial or complete new overview textual description to use (e.g., as part of generating a new dwelling occupancy description), such as generated based on an existing overview textual description or otherwise generated from other available information about the dwelling; a change to media items associated with the dwelling in the dwelling occupancy description, such as to remove one or more indicated media items, and/or to add one or more new media items of one or more types, and/or to modify one or more existing indicated media items; etc. For modifications corresponding to dwelling attributes and optionally their associated values, the dwelling attributes to consider for the modifications may in at least some embodiments be selected from all possible attributes based on one or more factors, such as attributes and/or associated values that are missing from an existing dwelling occupancy description, attributes whose values may be modified without structural changes to the dwelling (e.g., corresponding to occupancy policies for a dwelling available for rental; corresponding to features that may be added and/or removed, such as appliances and/or furniture and/or decorations; etc.), attributes having outsized effects on selection decisions for final dwellings (e.g., quantity of bedrooms, quantity of bathrooms, square footage of the dwelling, square footage of the dwelling's property, listing price, purchase price, etc.), etc., and may in some embodiments be dynamically selected for a particular dwelling occupancy description and/or associated target dwelling, and may in other embodiments be predefined before being used for particular dwelling occupancy descriptions and/or associated target dwellings.

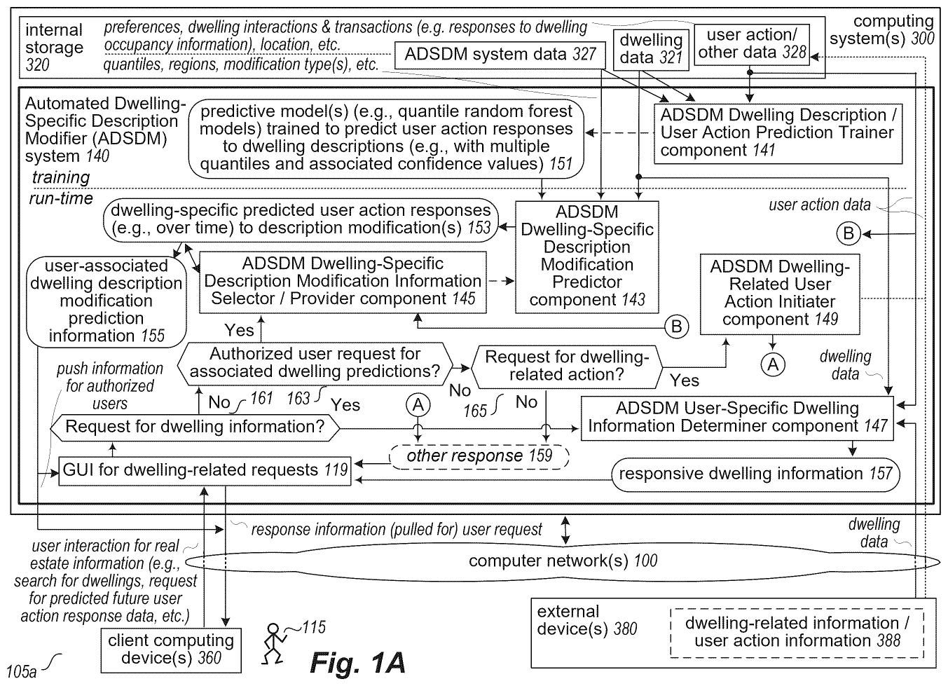

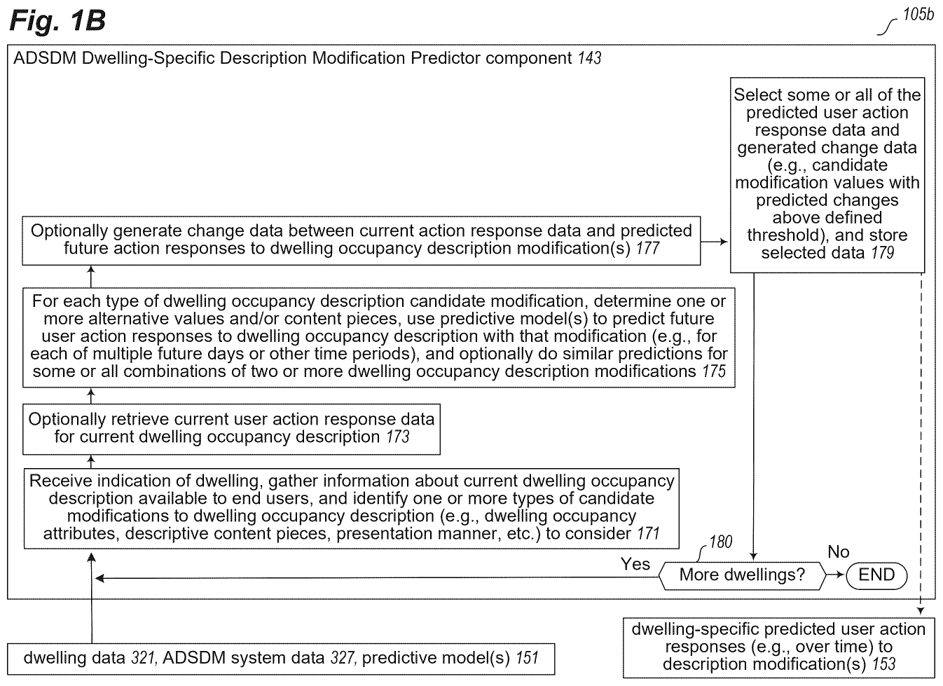

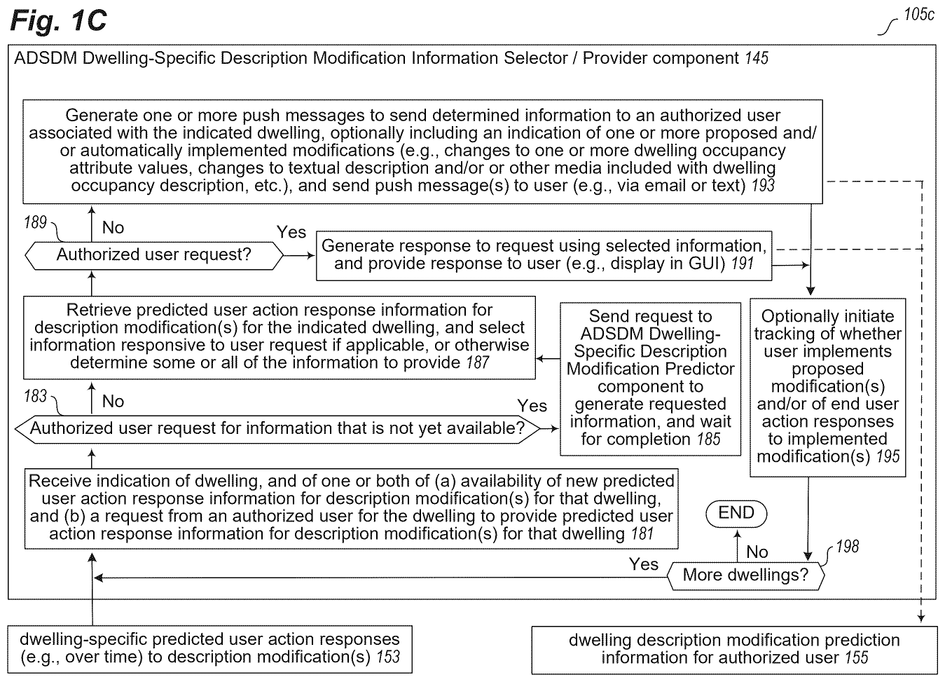

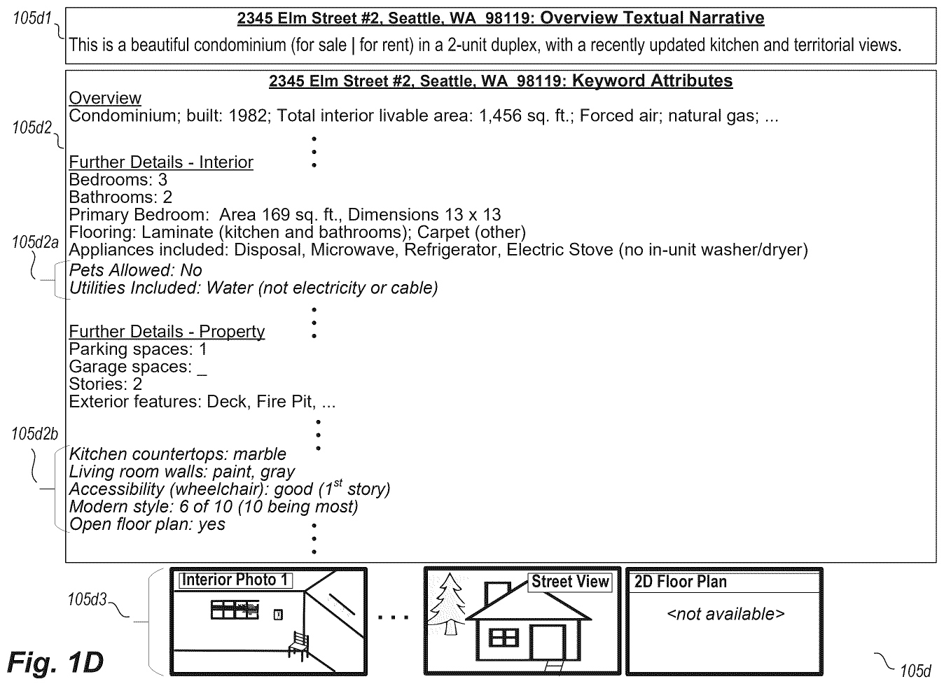

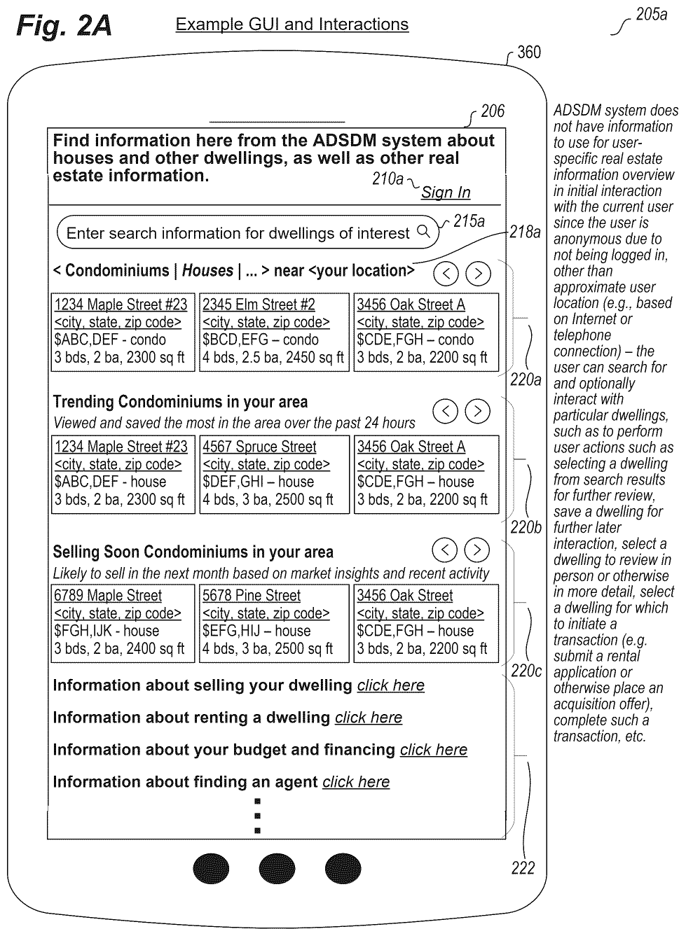

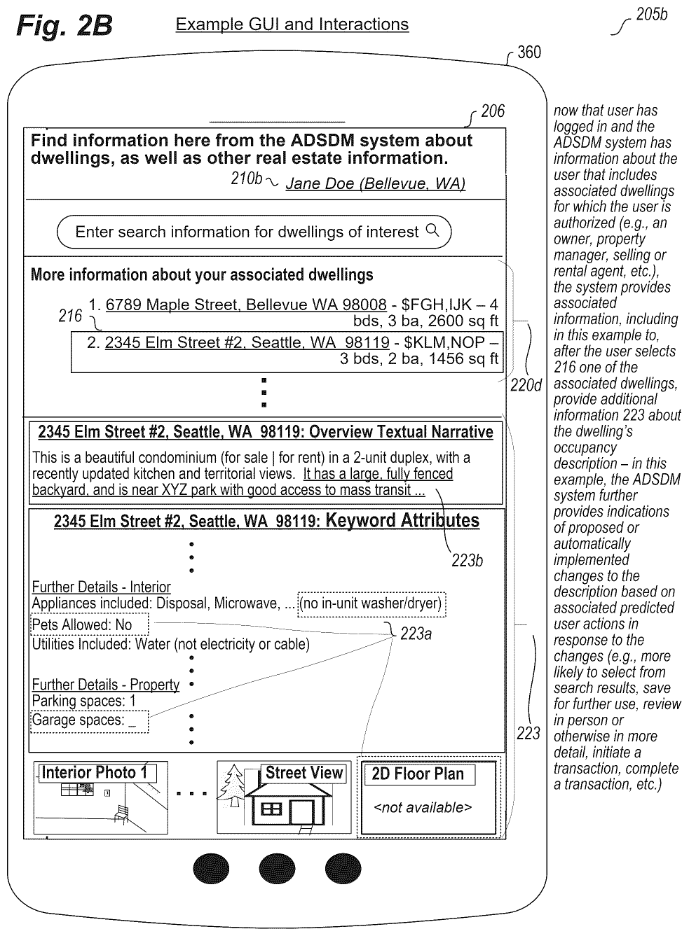

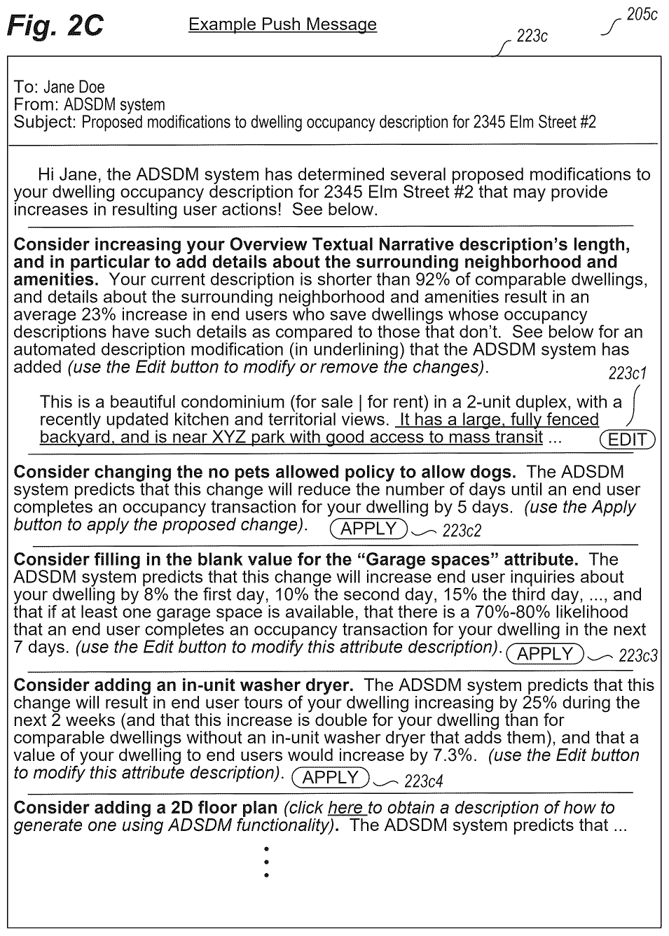

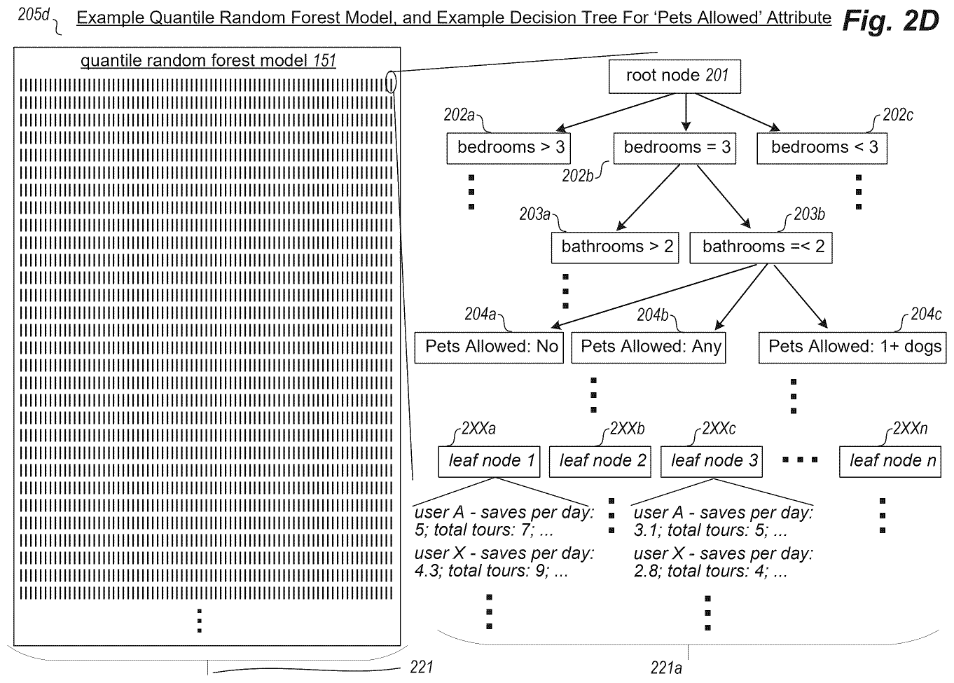

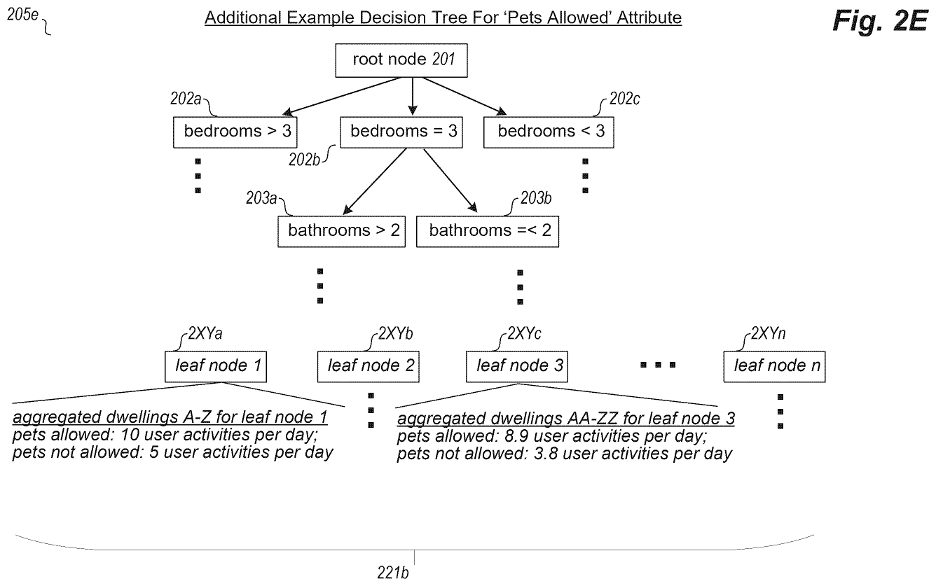

In addition, a dwelling occupancy description for an associated dwelling may be presented to or otherwise provided to an end user in various manners in various embodiments, such as with a manner of how to perform the presentation or other provision being selected from one or more of the following non-exclusive manners: using summary information about the associated dwelling that is a subset of the dwelling occupancy description as one of multiple search results or other groups of multiple dwellings (e.g., with all search results or other dwellings of a group displayed in a similar manner, optionally ranked by order of relevance, or by featured dwellings that are selected by the ADSDM system or promoted by payment from or other action of an associated authorized user, or by other criteria for an end user to which the search results are displayed; with certain selected dwellings in the search results or group being highlighted or otherwise presented in a more prominent manner, such as for featured dwellings and optionally using different colors and/or sizes for photos or other dwelling details and/or displayed badges and/or other visual indicators; etc.); with some or all of that dwelling occupancy description displayed to an end-user (e.g., after that end user selects the associated dwelling), such as to show at least some of an overview textual description and at least some of dwelling attributes with associated values (if any) and to optionally show some or all of at least some media items for the associated dwelling (e.g., thumbnail versions of associated images); with some or all of the dwelling occupancy descriptions for one or more associated dwellings being sent to the end user in one or more emails and/or other push electronic messages, optionally with particular dwellings being selected for inclusion and/or highlighted or otherwise presented in a more prominent manner for certain dwellings, such as featured dwellings; etc. In addition, one or more proposed and/or implemented dwelling occupancy description modifications for an associated dwelling may in at least some embodiments and situations include changes to a manner in which some or all of the modified dwelling occupancy description is presented to an end user, such as to change which subset of the modified dwelling occupancy description is included in summary information for the associated dwelling, by presenting some or all of the dwelling occupancy description in a manner to increase its ranking and/or highlighting with respect to information for other dwellings, to include the associated dwelling in a group of related dwellings, etc. Additional details are included below about dwelling occupancy descriptions and modifications to them, including in the examples of FIGS. 1D-2E.

As noted above, the automated operations of the ADSDM system in at least some embodiments include predicting user responses to dwelling occupancy description information for a target dwelling that may include predicted types and/or quantities of user interactions by end users with the target dwelling in response to viewing or otherwise receiving some or all of the target dwelling's dwelling occupancy description. Such interactions may be of various types in various embodiments, including the following non-exclusive examples: viewing online information about a target dwelling, such as after selecting the target dwelling; saving or adding a target dwelling to a user-specific online list or group for later review; selecting a target dwelling for further interaction (e.g., touring or otherwise visiting in person), requesting additional information about the target dwelling from an authorized user associated with the target dwelling, etc., as well as the one or more interactions involved in selecting a final dwelling to acquire and/or occupy and optionally performing a transaction to complete the acquisition and/or occupation.

As is also noted above, the automated operations of the ADSDM system in at least some embodiments include generating one or more predictive models trained to provide predicted information about future user responses based on particular types of information that are available to end users in a dwelling occupancy description of a target dwelling, such as using training data from numerous users' interactions with dwellings available to acquire and/or occupy and having various types of information in their associated dwelling occupancy descriptions. In at least some embodiments, a quantile random forest predictive model is generated and trained for one or more target attributes of interest for which modifications may be proposed and/or for other types of dwelling occupancy description modifications, such as with the quantile random forest model including numerous decision trees each specific to a type of modification (e.g., a specific attribute) and whose leaf nodes in aggregate include values for dwellings that the numerous users have interacted with that have various combinations of descriptive information (e.g., particular attributes and/or associated values), and optionally with the decision trees corresponding to random samples of the overall training data and having varying branches between their root and leaf nodes based on values of various dwelling occupancy description information (e.g., dwelling attributes and optionally associated values) of other dwellings that the users for those random samples interacted with—in this manner, the leaf nodes provide a full distribution of values across various combinations of attributes and associated values and/or other types of dwelling occupancy description information of previously interacted-with dwellings, and may be used to produce a predicted mean value for a specific target attribute or other target modification of interest, as well as predicted values for multiple other defined quantiles for that specific target attribute or other target modification of interest (e.g., for some or all single percentages, or percentiles, such as 1%, 2%, 3%, etc.; some or all multiples of 5 percentages, such as 5%, 10%, 15%, etc.; some or all multiples of 10 percentages, such as 10%, 20%, 30%, etc.; some or all quarter percentages, or quartiles, such as 25% and 75%; etc.). In at least some embodiments, such a quantile random forest predictive model is further generated and trained to provide at least one confidence value for one or more predicted values in light of a specific group of dwelling occupancy description information (e.g., multiple predicted values for multiple quantiles), such as to reflect variance in the full distribution in light of the specific group of dwelling occupancy description information in the training data. Other predictive model types may be used In other embodiments, whether in addition to or instead of quantile random forest models, such as other random forest models (e.g., generalized random forests that provide confidence intervals or values associated with a predicted mean value, such as for a 50% quantile; uplift random forests that provide a predicted amount or other impact resulting from a change; etc.), stacked classifiers, conditional means models, gradient boosting models (e.g., using a quantile loss function to generate quantile predictions), clustering models, neural network models, linear regression models, etc., including in at least some embodiments to predict multiple values over multiple future periods of time (e.g., one or more hours, days, weeks, months, etc.) using a survival curve analysis or other technique for estimating predicted values over time. In addition, multiple predictive models may be generated and used for dwelling occupancy description information in some embodiments, such as to segment each such predictive model by geographical region and/or dwelling occupancy type (e.g., rental, purchase, etc.) and/or type of future user interaction or other user response, as permitted by applicable laws and regulations. Additional details are included below related to types of predicted user interactions and other predicted user responses, and to generating one or more predictive models trained to provide information about one or more target dwelling attributes of interest using training data from numerous users' interactions with dwellings, including with respect to the non-exclusive examples of FIGS. 2A-2E.

As is also noted above, the automated operations of the ADSDM system in at least some embodiments include using one or more trained predictive models to automatically assist particular users in generating and/or modifying dwelling occupancy descriptions based at least in part on predicted future user responses to the generated and/or modified dwelling occupancy descriptions, such as for an authorized user associated with a target dwelling available for occupancy and/or acquisition (e.g., an owner; a user authorized by the owner, such as a property manager or real estate agent; etc.). In at least some embodiments, the use of the one or more trained predictive models may occur while an authorized user is interacting with a site or system that provides information about dwellings and optionally other types of real estate-related information, such as a site or system provided by the ADSDM system or using the ADSDM system—for example, the authorized user may submit one or more requests to the ADSDM system (e.g., via a GUI, or graphical user interface, of the ADSDM system), such as request(s) to provide predicted user response information for one or more indicated proposed dwelling occupancy description modifications; to provide recommendations for one or more proposed dwelling occupancy description modifications that are determined by the ADSDM system, such as those that provide a highest predicted change in one or more types of future user responses, and optionally in a manner that the authorized user may approve or confirm to use one or more such proposed dwelling occupancy description modifications (or may cancel or revert, if so selected, a proposed dwelling occupancy description modification that is determined by and automatically implemented by the ADSDM system); to provide a proposed new generated dwelling occupancy description based on other available information about a dwelling and based on predicted future user responses to particular dwelling occupancy description information included in it; to provide a grid or other group of alternative proposed dwelling occupancy description modifications with associated predicted future user response information from which the authorized user may select; etc. In some embodiments, the ADSDM system may automatically determine one or more proposed dwelling occupancy description modifications for a target dwelling that are not in response to a corresponding explicit request (e.g., periodically; at one or more defined times, such as before a target dwelling is made available to end-users and/or after a specified amount of time during which a target dwelling has been made available to end-users; etc.), such as with information about one or more proposed dwelling occupancy description modifications and associated predicted future user response information being provided to the authorized user in a push manner (e.g., via one or more electronic messages sent to the authorized user, such as the email, text, etc.; by displaying the information to the author's user in a GUI of the ADSDM system, such as a next time that the authorized user is interacting with the GUI; etc.), and in at least some embodiments and situations to notify the authorized user of one or more dwelling occupancy description modifications that the ADSDM system has automatically proposed and implemented. In addition, in at least some embodiments and situations, the ADSDM system generates a range of predicted values for each proposed dwelling occupancy description modification, such as using a predicted lower bound of the range corresponding to a first selected quantile (e.g., 5%, 15%, 25%, 35%, etc.) and a predicted upper bound of the range corresponding to a second selected quantile (e.g., 60%, 70%, 80%, 90%, 95%, etc.)—in other embodiments and situations, the ADSDM system may use a single predicted value for some or all proposed dwelling occupancy description modifications, such as a predicted mean or 50% quantile value, or other value. Additional details are included below related to using trained predictive models to automatically assist particular users in obtaining information about predicted future user responses for one or more proposed dwelling occupancy description modifications, including with respect to the non-exclusive examples of FIGS. 2A-2E.

The described automated techniques provide various benefits in various embodiments, including to significantly improve dwelling occupancy description information that is generated and provided to end users (e.g., in response to specified queries for information about dwellings satisfying one or more specified criteria, including queries specified in a natural language format), and to significantly improve functionality for authorized users to generate new and/or modified dwelling occupancy description information for associated dwellings. Such automated techniques also allow such dwelling occupancy description information to be generated much more quickly and efficiently than previously existing techniques (e.g., using less storage and/or memory and/or computing cycles) and with greater accuracy, based at least in part on using the described techniques for improving the accuracy and relevance of information provided to users in specific situations and for specific dwellings, etc. In addition, in some embodiments the described techniques may be used to provide an improved GUI (graphical user interface) in which a user may more accurately and quickly obtain real estate-related information, including in response to an explicit request (e.g., in the form of a natural language query), as part of providing personalized information to the user, etc. Various other benefits are also provided by the described techniques, some of which are further described elsewhere herein.

In at least some embodiments, some or all end user queries may be entered using multiple free-form natural language terms to specify one or more search criteria, and if so the ADSDM system may analyze such a query to determine the user-specified criteria to use, including by segmenting the terms in the received query into one or more segments each corresponding to an indicated search criterion. Such segmenting of the sequence of term(s) may be performed in various manners in various embodiments, such as by identifying matches in one or more dictionaries (e.g., general-purpose dictionaries, dictionaries of POI location names, dictionaries of geographical area names, etc.) or other lists of word/phrase breaks, by considering each combination of singleton terms and two or more adjacent terms to determine if they match POI locations or geographical areas (e.g., for a sequence of terms such as “Space Needle Seattle”, considering alternative name-based designations of “Space”, “Needle”, “Seattle”, “Space Needle”, “Needle Seattle”, and “Space Needle Seattle”, and concluding that “Space” is grouped with “Needle” to identify a POI location name, leaving the name-based designation of “Seattle” to identify a surrounding geographical area that together uniquely identify the POI location, such as to differentiate the Space Needle in Seattle from other space needles in other geographical areas), etc. In some embodiments, each combination of terms is treated as a separate segment (e.g., for a sequence of terms such as “Stamford New York”, using all of “Stamford”, “New”, “York”, “Stamford New”, “New York” and “Stamford New York” as separate segments), or search queries may be parsed without using such segments. In addition, in some embodiments and situations, the received query may include one or more segments for one or more search criteria of one or more specific types, such as one or more of the following: dwelling-type designations (e.g., ‘apartment’, ‘single family house’, ‘condominium’, etc.); POI categories (e.g., “beaches”, “parks”, “schools”, “hospitals”, “lakes”, etc.); indeterminate distance indications that are associated with one or more POI locations and/or POI categories (e.g., “nearby” or analogous terms such as “near”, “by”, “around”, “at”, “close to”, “adjacent”, etc.; a travel-based distance measure with an indicated travel type, such as walking or bicycling or scootering or driving or bus or train or light rail or mass transit; etc., and an associated amount of travel time that is specified or otherwise determined); non-location-related search filters or other search criteria, such as search criteria related to dwelling attributes (e.g., minimum and/or maximum and/or target price, number of bathrooms, number of bedrooms, etc.), etc. In some embodiments and situations, a received query may include only an indication of a POI location or a POI category, and other search criteria such as geographical area and/or dwelling type and/or indeterminate distance and/or other dwelling-related attributes may be automatically determined for use with the search query (e.g., inferred, selected as a default, etc.), optionally based on information specific to a user who submitted the search query and/or a current context (e.g., as part of an ongoing search interaction session by using previously specified details). Additional details are included herein related to analyzing a sequence of one or more terms of a received query that is specified using free-form natural language.

FIGS. 1A-1D are network diagrams illustrating an example system for performing described techniques, including automatically determining and using dwelling-specific predicted user responses to dwelling description information for a target dwelling, as well as to provide examples of non-exclusive types of dwelling description information.

In particular, FIG. 1A illustrates information 105a about an example embodiment of an ADSDM system 140 executing on one or more computing systems 300, and interacting over one or more computer networks 100 with one or more client computing devices 360, such as to receive query requests from end users 115 of the client computing devices for information about dwellings and to provide corresponding responses (e.g., as part of search results), and/or to provide information to authorized users 115 of the client computing devices about proposed dwelling occupancy description modifications, whether as pull information in response to corresponding requests from the authorized users and/or as push messages sent that are not in response to explicit corresponding requests. In the illustrated embodiment, the computing systems 300 may store various information on storage 320 that is used by the ADSDM system during operation, including dwelling data 321 about dwellings in one or more geographical areas (e.g., in one or more countries, states, cities, etc.), user action data and other user data 328 (e.g., user location; prior user interaction data for interactions of one or more types with dwellings via the ADSDM system, and optionally additional received interaction data for further interactions of the user outside the ADSDM system with one or more dwellings, including in-person interactions and transactions to acquire and/or occupy particular dwellings; user preferences, such as expressly specified and/or implicitly determined from past activities of the user such as viewing or otherwise interacting with information about dwellings; etc.), and ADSDM system data 327 (e.g., stored in one or more databases, such as about geographic regions; target types of dwelling occupancy description modifications to consider, such as for particular dwelling attributes; quantiles to use with quantile random forests and/or other predictive models; names and locations of POI locations and associated POI categories; data for use in determining distances of one or more types between two or more geographical locations; information for use in segment determination such as word-break and/or phrase-break vocabularies; etc.). The ADSDM system may further optionally retrieve and use other dwelling-related information and/or user action information 388 of one or more types stored externally to the computing systems 300, such as accessed over the one or more computer networks 100 from one or more external computing and/or storage devices 380, whether in addition to or instead of information stored on storage 320, and optionally including information about user interactions outside of the ADSDM system with dwellings and about additional dwelling-related data.

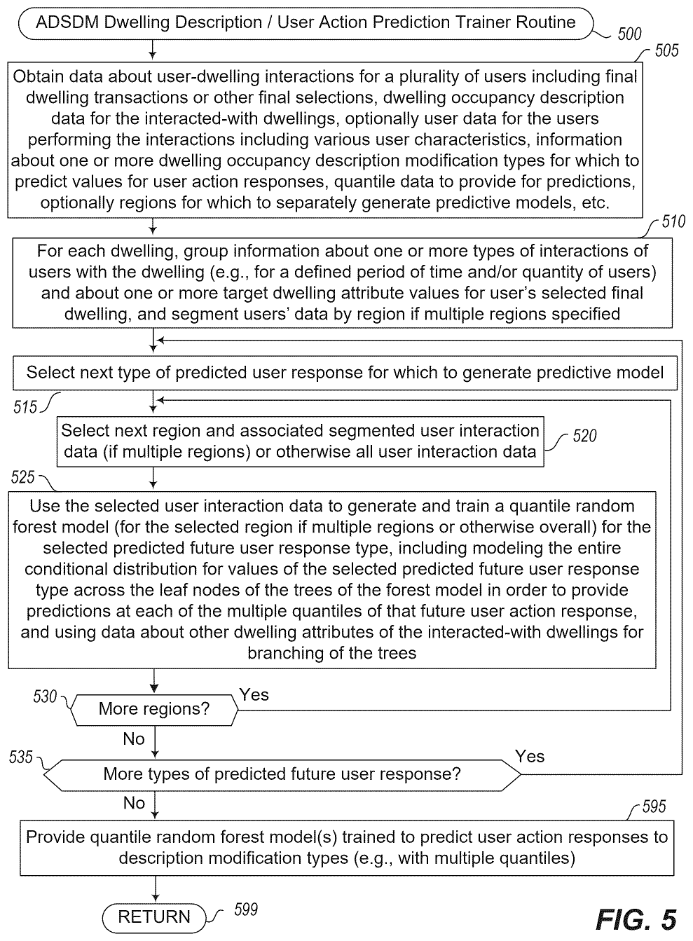

As one example of operations of the ADSDM system 140, an ADSDM Dwelling Description/User Action Prediction Trainer component 141 performs activities to generate and train one or more predictive models 151 (e.g., quantile random forests models) for use in predicting values for one or more future user interactions values or other future user responses by end users who receive particular dwelling occupancy description information (e.g., with particular proposed dwelling occupancy description modifications), including to obtain, as input, dwelling data 321 about dwellings (including dwelling occupancy descriptions of the dwellings with dwelling attributes and other information about the dwellings), user data 328 (including information about user preferences, prior user dwelling interactions, user location, etc.), and one or more types of ADSDM system data (e.g., information about one or more target dwelling attributes and/or other types dwelling occupancy description modifications for which to generate and train one or more predictive models, optionally about regions for which to generate and train region-specific predictive models, optionally about one or more types of available dwellings for which to generate and train dwelling-specific quantile random forest models, optionally quantiles for which to generate information from the trained predictive models, etc.). Additional details are included elsewhere herein related to the generation and training of the one or more predictive models 151, including in FIG. 5 that provides further details related to one example embodiment of operations of such a component 141.

After the one or more predictive models 151 have been generated, the example operations may further include an ADSDM Dwelling-Specific Description Modification Predictor component 143 that uses the one or more predictive models 151 to generate dwelling-specific predicted future user action responses 153 (e.g., for each of multiple future periods of time) for each of one or more dwelling occupancy description modifications for one or more dwellings, such as in response to a request from an authorized user for one or more modifications for an associated dwelling, and/or proactively for each of one or more dwellings and associated dwelling occupancy description modifications that are automatically selected by the component 143 (e.g., for some or all dwellings available for each of one or more types of acquisition and/or occupancy, and one or more predetermined types of proposed dwelling occupancy description modifications)—FIG. 1B provides additional details regarding operations of the component 143 in one example embodiment. In addition, the example operations may further include a particular authorized user 115 of one of the client computing devices 360 supplying a request for predicted future user action response information for one or more types of proposed dwelling occupancy description modifications for one or more associated dwellings that are already available or to be available for occupancy and/or acquisition to GUI 119 provided by the ADSDM system, and/or an end user 115 of one of the client computing devices 360 supplying a query for dwelling-related information (e.g., about one or more criteria in a natural language free-form input for use in identifying particular dwellings of interest) or other request to GUI 119 provided by the ADSDM system. The operational flow then proceeds to block 161 to determine if the received query is a request for dwelling information, and if so continues to perform ADSDM User-Specific Dwelling Information Determiner component 147 to analyze the received query to determine any user-specified criteria (e.g., search criteria, such as dwelling type, geographic region, dwelling attributes and optionally associated values, etc.), analyze the dwelling data 321 and optionally other dwelling-related information 388 to identify any matching dwellings, optionally uses user-specific and/or dwelling-specific information (e.g., corresponding to associated dwelling occupancy determination modifications made to change a manner in which the associated dwelling information is present) to rank and/or filter the matching dwellings in order to generate responsive dwelling information search results 157, which are then provided to the GUI 119 for use in response to the query.

If it is instead determined in block 161 that the received query is not a request for dwelling information, the operational flow then proceeds to block 163 to determine if the received query is a request from an authorized user for predicted future user action response information for one or more types of proposed dwelling occupancy description modifications for one or more associated dwellings, and if so proceeds to perform ADSDM Dwelling-Specific Description Modification Information Selector/Provider component 145 to retrieve corresponding user-associated dwelling description modification prediction information 155 that is responsive to the request from the dwelling-specific predicted future user action responses 153, or if the responsive information is not yet available, to send a corresponding request to the component 143 to generate such information 153 and to wait for the generation of the responsive information—FIG. 1C provides additional details regarding operations of the component 145 in one example embodiment. The responsive information 155 is then provided to the authorized user via the GUI 119 as a response to the request (e.g., by displaying corresponding information to the authorized user in the GUI). Alternatively, in at least some embodiments and situations in which the component 143 proactively generates dwelling-specific predicted future user action response data 153 for one or more dwellings and one or more associated dwelling occupancy description modifications, the system 140 may further push some or all such predicted data 153 to one or more such authorized users, such as via electronic messages sent to the client computing devices 360 separate from the GUI 119.

If it is instead determined in block 163 that the received query is not a request from an authorized user for predicted future user action response information for one or more types of proposed dwelling occupancy description modifications for one or more associated dwellings, the operational flow then proceeds to block 165 to determine if another type of request is received from an end user corresponding to performing one or more user interactions with a selected dwelling for which the end user has previously received some or all dwelling occupancy description information for the selected dwelling (e.g., including dwelling occupancy dwelling modifications previously proposed and/or automatically implemented by the ADSDM system 140)—if so, the operational flow proceeds to perform ADSDM Dwelling-Related User Action Initiator component 149 to initiate the corresponding user interaction(s) with the selected dwelling, with corresponding user action data added to the user data 328, and the operational flow continuing to optionally generate a corresponding response 159 (e.g., about results of the one or more user interactions), and if so to send the other response 159 to the end user via the GUI 119. If it is instead determined in block 165 that the received query is not a request from an end user corresponding to performing one or more user interactions with a selected dwelling, the operational flow continues instead to optionally generate another response 159 to the received request as appropriate, and if so to send the other response 159 to the end user via the GUI 119.

The same user may then provide one or more subsequent queries to the GUI 119 as part of an ongoing interaction session, such as with similar processing performed for the subsequent user queries, and optionally with the context of prior interactions during the session being maintained and used by the ADSDM system. In addition, a user may in some embodiments and situations provide optional user feedback, such as to provide feedback regarding accuracy of response information or to provide further clarifying information in response to a corresponding request or to specify further user preferences to be used, etc.—if so, such optional user feedback may be forwarded to the components 141 and/or 143 and/or 145 and/or 147 and/or 149 or otherwise used by the ADSDM system, such as to improve future determinations performed by the components. In other embodiments and situations, some or all such feedback may instead be implicit feedback that is determined based on an analysis of subsequent user queries (e.g., to indicate that a prior query response did not provide information that the user was seeking) and/or of prior user queries (e.g., to determine user preferences and/or user location, such as based on patterns in the prior user queries). While the example discussed above involves a single user performing multiple interactions with the ADSDM system as part of an interaction session (e.g., spanning seconds, minutes, hours, days, etc.), it will be appreciated that the ADSDM system may in at least some embodiments and situations be concurrently interacting with many users using different client computing devices, such as to maintain a separate GUI and interaction session history for each such user, and that a new interaction session may be initiated for a user after one or more prior interaction sessions with that user in various manners (e.g., based on a corresponding user instruction, such as to reflect a change in the types of dwelling information of interest; as determined automatically by the ADSDM system, such as to reflect a change in the types of dwelling information being requested, or due to a defined period of time since a last user interaction being exceeded, such as one or more days; etc.).

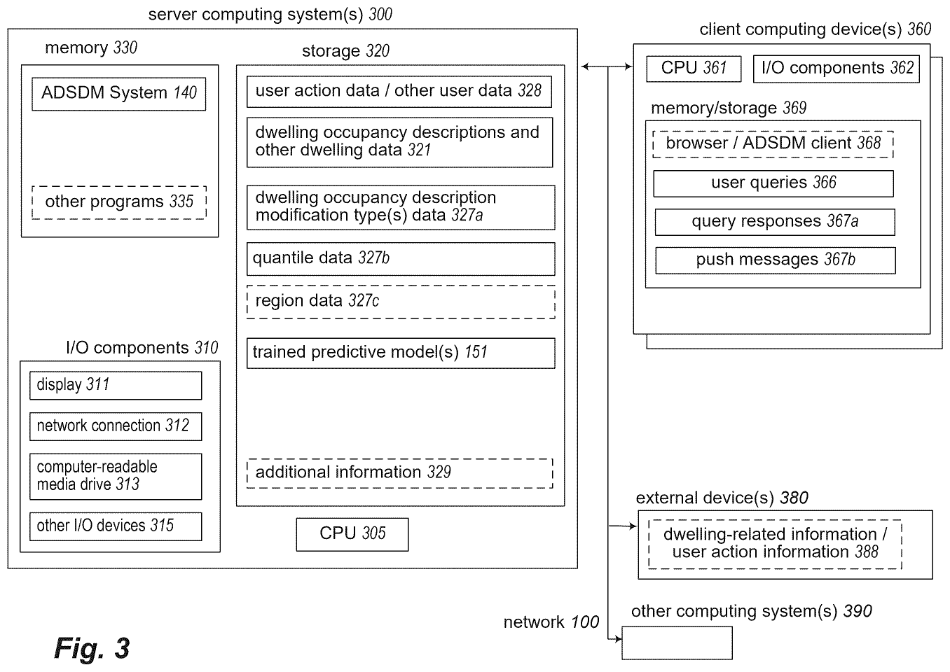

In addition, the computing system(s) 300 may include various other components and functionality, as discussed in greater detail elsewhere herein, including with respect to FIG. 3. The computer networks 100 may similarly be of various types in various embodiments and may include various types of wired and/or wireless segments, including one or more publicly accessible linked networks (e.g., operated by various distinct parties, such as the Internet) and/or a private network (e.g., a corporate or university network that is wholly or partially inaccessible to non-privileged users), including in some cases to have both private and public networks (e.g., with one or more of the private networks having access to and/or from one or more of the public networks).

FIG. 1B continues the example of FIG. 1A, and illustrates information 105b for one example embodiment of the ADSDM Dwelling-Specific Description Modification Predictor component 143 discussed in FIG. 1A. In particular, in the illustrated embodiment, the component 143 performs various activities to use the one or more predictive models 151 to generate dwelling-specific predicted future user action response data 153 (e.g., for each of multiple future periods of time) for each of one or more dwelling occupancy description modifications for one or more dwellings, such as in response to a request from an authorized user with respect to one or more indicated modifications for an associated dwelling, and/or proactively for each of one or more dwellings and associated dwelling occupancy description modifications that are automatically selected by the component 143 (e.g., for some or all dwellings of one or more types, such as dwellings available for acquisition and/or occupancy, and for one or more types of proposed dwelling occupancy description modifications, such as for predetermined types and/or based at least in part on a current dwelling occupancy description, including to add missing information, correct mistakes, make improvements of one or more types, etc.).

In operation, the component 143 receives, as input, dwelling data 321 about various dwellings in one or more geographical regions that are available for occupancy and/or acquisition (including dwelling occupancy descriptions for the dwellings), and one or more types of ADSDM system data 327 (e.g., geographic regions; target types of dwelling occupancy description modifications to consider, such as for particular dwelling attributes; quantiles to use with quantile random forests and/or other predictive models; etc.). In block 171, the component 143 receives an indication of a target dwelling (e.g., from a request from an associated authorized user, by selecting one of multiple available dwellings for which to generate predictions, etc.), gathers information about a current dwelling occupancy description available to end users (if any) for the dwelling, and identifies one or more types of candidate modifications to make with respect to the existing dwelling occupancy description (e.g., with respect to one or more target dwelling occupancy attributes, an overview textual description, associated descriptive media items or other content pieces, a manner of presenting the dwelling occupancy description, etc.)—if a current dwelling occupancy description does not exist, the component 143 may instead perform operations to consider a variety of alternative values with respect to each type of candidate modification, such as for use in selecting a best group of associated attribute values and/or other dwelling occupancy description pieces of data as part of automatically generating a proposed new dwelling occupancy description. In block 173, the component then optionally retrieves current user action response data for the current dwelling occupancy description (if any), such as to reflect a current dwelling occupancy description that has already been in use and presented to a variety of end-users but for which the associated dwelling has not yet had a completed transaction to occupy and/or acquire the dwelling. In block 175, the component then, for each type of dwelling occupancy description candidate modification, determines one or more alternative values and/or content pieces to use for that modification (e.g., using an enumerated set of possible values for a particular dwelling attribute, using an enumerated list of types of media items for a dwelling occupancy description, using an enumerated list of types of details to include in an overview textual description, by determining variations for a current attribute value, etc.), and uses the one or more predictive models to predict future action responses to a dwelling occupancy description that includes each such alternative value and/or content piece for that type of modification, including in at least some embodiments and situations to predict future quantities of user interactions or other types of future user action responses for each of multiple future days or other future periods of time. In at least some embodiments and situations, the component may further generate such predicted future user action responses for combinations of two or more dwelling occupancy description modifications, such as for some or all combinations of possible values or content items or alternative text for each such dwelling occupancy description modification included in the combination (e.g., for all possible combinations of possible values or content items or alternative text for two or more dwelling occupancy description modifications,, for all combinations of two or more dwelling occupancy description modifications, etc.). In block 177, the component then optionally generates change data to reflect differences between current user action response data (if available) and the predicted future user action response data, and in block 179 then selects some or all of the predicted user action response data and (if available) generated change data to retain and store as dwelling-specific predicted user action responses 153 to description modifications (e.g., all predicted and generated data; predicted and generated change data for dwelling occupancy description candidate modifications having a highest predicted change from current action response data and/or otherwise having a highest predicted value for one or more target types of user action responses, such as highest predicted quantities of user interactions of one or more specified types; etc.), and optionally notifies component 145 of the availability of the new dwelling-specific predicted user action responses to description modification data 153 for use in optionally proactively sending some or all such new data to one or more corresponding authorized users associated with one or more dwellings to which the new data pertains. In block 180, the component then determines if there are more dwellings for which to generate the predicted future user action responses, such as if an authorized user has requested such information for multiple associated dwellings or if the component 143 is proactively generating such data for multiple available dwellings, and if so returns to block 171 to perform similar processing for a next such indicated dwelling, and otherwise ends and returns.

FIG. 1C continues the examples of FIGS. 1A-1B, and illustrates information 105c for one example embodiment of the ADSDM Dwelling-Specific Description Modification Information Selector/Provider component 145 discussed in FIG. 1A. In particular, in the illustrated embodiment, the component 145 performs various activities to retrieve dwelling description modification prediction information 155 from the dwelling-specific predicted future user action response data 153 that is either responsive to a request received from an authorized user (or if the responsive information is not yet available, to initiate its generation by sending a corresponding request to the component 143 and waiting for the generation of the responsive information), or to push dwelling description modification prediction information 155 from new dwelling-specific predicted future user action response data 153 that is proactively generated by the component 143 to one or more associated authorized users.

In operation, the component 145 receives, as input, previously generated dwelling-specific predicted future user action response data 153. In block 181, the component 145 receives an indication of a dwelling from one or both of an authorized user request for predicted user action response information for that dwelling, or as an indication of availability of newly generated predicted user action response data for that dwelling (e.g., from the component 143), and in block 183 determines if the received indication corresponds to an authorized user request for information that is not yet available. If so, the component 145 in block 185 sends a corresponding request to the component 143 to generate corresponding request information, and waits for completion before proceeding. After block 185, or if it is instead determined in block 183 that the indication of the dwelling is not part of an authorized user request for information that is not yet available, the component 145 in block 187 retrieves corresponding predicted user action response data for the indicated dwelling (e.g., all available predicted response data for the indicated dwelling; predicted response data with respect to one or more indicated candidate dwelling occupancy description modifications; etc.), and selects information responsive to the user request if applicable (e.g., for one or more indicated candidate dwelling occupancy description modifications), or otherwise determine some or all of the retrieved information to provide to an authorized user for the dwelling (e.g., all predicted response data, predicted response data for one or more candidate modifications having highest associated predicted user response data, etc.). In block 189, the component 145 then determines if the received indication of the dwelling was part of a request from an authorized user, and if so proceeds to block 191 to generate a response to the request using the information selected in block 187, and proceeds to provide corresponding responsive dwelling occupancy description modification prediction information 155 to the authorized user (e.g., via a display of corresponding information in a GUI of the ADSDM system, or to otherwise respond to the request from the authorized user in a manner that it was received or as otherwise indicated by the authorized user). Otherwise, the component 145 proceeds to block 193 to generate one or more push messages to send corresponding responsive dwelling occupancy description modification prediction information 155 determined in block 187 to an authorized user associated with the indicated dwelling, such as to optionally include information about one or more proposed and/or automatically implemented modifications to a dwelling occupancy description for the indicated dwelling, and sends the one or more push messages to the authorized user (e.g., via electronic communications sent via email or text). After blocks 191 or 193, the component 145 in block 195 optionally initiates tracking of whether the authorized user for the indicated dwelling implements proposed modifications provided to the authorized user (or cancels or reverts proposed modifications that were automatically implemented by the component 145), such as to update user-specific information for the authorized user corresponding to preferences of the authorized user, and/or optionally initiates tracking of actual end user responses to implemented dwelling occupancy description modification(s), such as to track differences between predicted and actual user responses for use in updating training of the predictive model(s) 151 in use. After block 195, the component 145 determines in block 198 if there are more dwellings for which to provide dwelling occupancy description modification prediction information, such as if an authorized user had requested such information for multiple associated dwellings or if the component 143 indicated the availability of corresponding new predicted data for multiple available dwellings, and if so returns to block 181 to perform similar processing for a next such indicated dwelling, and otherwise ends and returns.

FIG. 1D illustrates examples of non-exclusive types of dwelling occupancy description information 105d that may be available in some embodiments for an example dwelling (in this example, a condominium available for rental and/or purchase), such as existing building information that is subsequently analyzed and used by the ADSDM system. In the example of FIG. 1D, the dwelling occupancy description information 105d includes an overview textual narrative description 105d1, various keyword attribute data 105d2, and various associated digital media items or other content pieces 105d3, such as may be used in part or in whole as listing information for an MLS system. In this example, the attribute data is grouped into sections (e.g., overview attributes, further interior detail attributes, further property detail attributes, etc.), with most of the attribute data specified using keyword-value pairs each having a keyword and at least one corresponding value (although other attributes may be specified using a keyword without any associated values, such as based on the presence or absence of a keyword such as “deck” or “pool”), but in other embodiments the attribute data may not be grouped or may be grouped in other manners and may be specified in other manners, including for the dwelling occupancy description information to not be separated into a list of attributes and a separate overview textual narrative description. In this example, the separate overview textual narrative description emphasizes characteristics that may be of interest to viewers, such as a dwelling style type, information of interest about rooms and other dwelling characteristics (e.g., have been recently updated or have other characteristics of interest), information of interest about the property and surrounding neighborhood or other environment, etc. In addition, in this example, the attribute data includes objective attributes of a variety of types about rooms and the dwelling and limited information about appliances, but may lack details of various types shown in italics in this example for attributes 105d2b (e.g., about subjective attributes, about inter-room connectivity and other adjacency, about other particular structural elements or objects and about attributes of such objects, etc.), such as may instead be determined by the ADSDM system via analysis of building images and/or other building information (e.g., floor plans), and/or may lack details of various types shown in italics in this example for attributes 105d2a (e.g., about attributes associated with rental usage policies, such as if the dwelling is only available for acquisition). In addition, in this example, the digital media items or other content pieces 105d3 include multiple dwelling images (both inside and outside in this example), but do not include a 2D floor plan or various other types of digital media items (e.g., audio clips, video clips, a 3D computer model, a virtual tour of inter-linked images through which a viewer may progress in a user-selected and/or automated manner, etc.).

It will be appreciated that various details are provided with respect to FIGS. 1A-1D for illustrative purposes, and are not intended to limit the scope of the invention unless otherwise indicated. Similarly, additional exemplary details are provided with respect to FIGS. 2A-2E and elsewhere herein, and such details are similarly provided for illustrative purposes and are not intended to limit the scope of the invention unless otherwise indicated.

FIGS. 2A-2E illustrate examples of performing described techniques, including automatically determining and using dwelling-specific predicted user responses to dwelling description information for a target dwelling.

In particular, FIG. 2A illustrates information 205a including an example client computing device 360 (in this example, a smartphone) that is being used by a user (not shown) to interact with a GUI provided by the ADSDM system, with current information 206 displayed in the GUI. In this example, the current information 206 corresponds to overview dwelling-related information provided in response to a previous request (e.g., a request to load a home page of a corresponding Web site), with the displayed information including a search box 215a, a user-selectable control 210a via which the user may sign in, and various groups of information 220 and 222 related to multiple types of dwelling-related information. In this example, the displayed information includes a first group of information 220a to show information about specific example condominiums near the user's location 218a (e.g., based on an automatically determined location of the user or the user's client device), which in this example includes three example condominiums and user-selectable controls to view additional condominiums of that type—information about other types of dwellings (e.g., apartments, houses, etc.) may be provided, whether in addition to or instead of condominiums. The example provided information further includes a second group of information 220b about trending condominiums in a geographical area of the user (e.g., that were viewed and saved the most in the prior 24 hours), which again in this example includes three example condominiums and corresponding user-selectable controls to view additional condominiums of that type—in a similar manner to information 220a, information about other types of dwellings may be provided, whether in addition to or instead of condominiums. The example provided information also includes a third group of information 220c about condominiums expected to sell soon in a geographical area of the user, which in this example also includes three example condominiums and corresponding user-selectable controls to view additional condominiums of that type—in a similar manner to that of information 220a and 220b, information about other types of dwellings may be provided, whether in addition to or instead of condominiums. The example provided information further includes additional information 222 related to real estate but not specific to particular dwellings, such as general information about selling or renting dwellings, about budget and financing, about finding a real estate agent, etc. In this example, since the user is not signed in, the initially provided information does not include information specific to the user (e.g., associated dwellings for which the user is an authorized user, based on prior interactions with the user during a current and/or prior interaction sessions, etc.).

FIG. 2B continues the example of FIG. 2A, and illustrates information 205b showing updated dwelling-related information after the user has logged in 210b, which again includes the search box, but in this example further includes additional dwelling-related information that is specific to the user. In particular, in this example, the provided information includes a group of information 220d about one or more dwellings for which the current user is an authorized user (which in this example includes two or more dwellings), and with the user having selected 216 a particular one of the dwellings (corresponding to the condominium for which an example dwelling occupancy description was provided with respect to FIG. 1D). In this example, the provided information further includes information 223 about the selected dwelling, including to show at least some of the current dwelling occupation description for the selected dwelling, as well as to show multiple proposed modifications to the current dwelling occupation description based at least in part on corresponding predict future user responses to such modifications. In this example, proposed modifications 223a correspond to three dwelling attributes and one media items, with the ADSDM system providing additional information (not shown) corresponding to these proposed modifications, such as an indication of a type of proposed modification, information about why the modification is proposed, information about predicted future user responses corresponding to the proposed modification, etc.—FIG. 2C provides additional details associated with such proposed modifications and corresponding provided additional information. In this example, one of the three dwelling attributes for which a modification is proposed is a “Pets Allowed” dwelling rental attribute with the current value of “No”, with the ADSDM system proposing to change the value to “Yes”, such as to increase the quantity of end-users who will view a modified version of the dwelling occupancy description with the proposed modification and/or who will select the modified version of the dwelling occupancy description for further use, to increase a speed at which an end user will initiate a transaction to occupy the dwelling (or correspondingly decrease a quantity of days or other future time periods until such an event), etc. In addition, another of the three dwelling attributes in this example attributes for which a modification is proposed is a “Garage spaces” dwelling attribute which currently does not have a value, with the ADSDM system proposing to add a value, such as to increase the quantity of end-users who select the dwelling for further interaction without first making inquiries to an associated authorized user about whether the dwelling includes a garage space (or correspondingly decrease the number of such inquiries), to increase the quantity of end-users who select the dwelling for further interaction if the modified quantity indicates one or more garage spaces are available, etc. In addition, the third dwelling attribute in this example attributes for which a modification is proposed is an indication that an in-unit washer/dryer appliance is not provided, with the ADSDM system proposing to consider adding such an appliance, such as to increase the speed at which an end user will initiate a transaction to occupy the dwelling, to increase a rental value at which the dwelling is rented, etc. In this example, the indicated media item attributes for which a modification is proposed is a 2D floor plan that is not available, with the ADSDM system proposing to add such a media item, such as to increase the quantity of end-users who select the dwelling for further interaction without first making inquiries to an associated authorized user about the floor plan, to increase the speed at which an end user will initiate a transaction to occupy the dwelling, etc. In addition to the proposed modifications 223a, the ADSDM system in this example further has automatically implemented a proposed modification 223b to the overview textual narrative description for the dwelling, including in this example to propose additional text to add to provide details about a surrounding property and/or neighborhood for the dwelling, such as to increase the quantity of end-users who select the dwelling for further interaction without first making inquiries to an associated authorized user about such information, to increase the speed at which an end user will initiate a transaction to occupy the dwelling, etc.—while not illustrated here, the authorized user may interact with the GUI to cancel the automatically implemented proposed modification and revert to the prior version of the dwelling occupancy description if it is not desired to be included, while in other embodiments, the ADSDM system may not automatically implement such proposed modifications, such as to instead provide suggestions to the authorized user that the authorized user can accept or select.

FIG. 2C continues the examples of FIGS. 2A-2B, and illustrates information 205c showing additional examples of using predicted future user responses to proposed dwelling occupancy description modifications to provide information to a user, which in this example includes sending one or more push messages to the authorized user (in this example, an email) to provide information 223c about the same types of proposed modifications 223a and 223b of FIG. 2B, but with additional information displayed about the corresponding predicted future user responses to such modifications. In particular, in this example, the ADSDM system includes a user-selectable control 223c1 with which the recipient authorized user can choose to cancel, revert or otherwise edit the proposed modification to the dwelling occupancy description's overview textual narrative, along with additional details about why the modification is proposed and associated predicted future response information (in this example corresponding to an increase in predicted future user interactions involving saving the dwelling for later use). Similarly, the provided information in this example for the three attributes for which proposed modifications were included have respective user-selectable controls 223c2-223c4 for the proposed modifications via which the authorized user can select to implement zero or some or all of the proposed modifications, as well as similarly providing additional details about why the modifications are proposed and associated predicted future user response information (in this example, predicted increases in a speed at which an end user completes an occupancy transaction, predicted increases in end user inquiries about the dwelling of specific predicted amounts for each of multiple future days, a predicted range of likelihoods that an end user completes an occupancy transaction for the dwelling during a future specified period of time, predicted increases in the quantity of end user in-person tours of the dwelling, predicted increases in a value of the dwelling at which end-users will rent it, etc.). In addition, the provided information in this example for the proposed modification to the media item includes a user-selectable control via which the authorized user can initiate functionality of the ADSDM system to generate a 2D floor plan of the dwelling to be added to its dwelling occupancy description.

FIG. 2D continues the examples of FIGS. 2A-2C, and illustrates information 205d showing an example quantile random forest model 151, which in this example is generated based on training data for dwellings of an indicated type (e.g., rentals, not shown) in an indicated geographical region (not shown). In this example, the model 151 includes numerous individual decision trees 221, with part of one specific decision tree 221a shown in additional detail corresponding to particular proposed dwelling occupancy description modification (in this example, for the “Pets Allowed” attribute), such as based on a random subset of the training data, and with other decision trees corresponding to other types of proposed dwelling occupancy description modifications. In this example, the branching from the root node 201 of the decision tree 221a is based on values of a dwelling attribute corresponding to quantity of bedrooms, with each of the three nodes 202a-c at the first level having branching for a next level based on another dwelling attribute—in this example, the second level is shown only for node 202b, with its branching corresponding to a dwelling attribute for quantity of bathrooms and having two corresponding nodes 203a-b. The illustrated branching continues through several levels, including for node 203b to have a branching level based on a dwelling attribute of pets allowed (as illustrated, with three corresponding nodes 204a-c shown for it in this example). The final leaf nodes 2XXa-n in this example each are associated with different groups of users from the subset of training data used for this decision model 221a, and corresponding to the users in that subset of training data whose user-dwelling interaction data causes them to reach that leaf node in the tree (e.g., using average or other aggregate values for the various dwellings that a user has previously interacted with), and with each leaf node showing aggregated data for one or more types of user responses by those users corresponding to interacted-with dwellings having dwelling attributes matching the path to that leaf node. This information may be subsequently used by the ADSDM system in predicting future responses of end users to a new dwelling, such as by identifying leaf nodes in the random forest model whose paths correspond to attributes and other data of the new dwelling's dwelling occupancy description, and determining how different values for one or more selected proposed modifications result in differing associated user response data. It will be appreciated that each decision tree may have a separate branching structure corresponding to the subset of training data used for its generation and training.

FIG. 2E continues the examples of FIGS. 2A-2D, and illustrates information 205e showing an alternative example decision tree for an example quantile random forest model (not shown) or other predictive model, which in this example is generated based on training data for dwellings of an indicated type (e.g., rentals, not shown) in an indicated geographical region (not shown). In this example, the decision tree 221b corresponds to the same type of proposed dwelling occupancy description attribute of FIG. 2D (in this example, for the “Pets Allowed” attribute), but without an intermediate level of nodes that includes decisions based on a dwelling attribute of pets allowed, and with the final leaf nodes 2XYa-n in this example each being associated with different groups of dwellings from the subset of training data used for this decision tree 221b. In this example, aggregated data for the “Pets Allowed” attribute are determined for each leaf node for the group of dwellings associated with that leaf node (dwellings having dwelling attributes matching the path to that leaf node), with the aggregated data reflecting, for some of the associated group of dwellings for that leaf node that allow pets, an average quantity of one or more types of user activities (e.g., viewing online information about a target dwelling; saving or adding a target dwelling to a user-specific online list or group for later review; selecting a target dwelling for further interaction; requesting additional information about the target dwelling from an authorized user associated with the target dwelling; selecting a final dwelling to acquire and/or occupy; performing a transaction to complete the acquisition and/or occupation; etc.) with those dwellings, and for other of the associated group of dwellings for that leaf node that do not allow pets, an average quantity of those one or more types of user activities with those dwellings—in this manner, differences in the quantities of those one or more user activity types may be determined for otherwise similar dwellings that have different policies on allowing pets. This information may be subsequently used by the ADSDM system in predicting future responses of end users to a new dwelling, such as by identifying leaf nodes in the random forest model whose paths correspond to attributes and other data of the new dwelling's dwelling occupancy description, and determining how different values for a proposed modification to that new dwelling's policies regarding allowing pets results in differing associated user response data.

It will be appreciated that the examples of FIGS. 2A-2E are provided for illustrative reasons only, and are not intended to limit the scope of the invention. For example, a variety of other combinations of natural language free-form search terms may be used in other embodiments and situations.

In addition, further details related to at least some operations of the ADSDM system and its components are included in U.S. Non-Provisional patent application Ser. No. 18/583,602, filed Feb. 21, 2024 and entitled “Automated Tool For Determining And Providing Building Information For Multiple Partially Described Proximate Geographical Regions”; in U.S. Non-Provisional patent application Ser. No. 18/642,246, filed Apr. 22, 2024 and entitled “Automated Tool For Determining And Using User-Specific Predicted Attributes Of Dwellings That Users Will Later Occupy”; in U.S. Non-Provisional patent application Ser. No. 18/734,815, filed Jun. 5, 2024 and entitled “Automated Tool For Determining And Providing Information About Dwellings Satisfying Search Criteria Specified Using Multiple Data Modes”; in U.S. Non-Provisional patent application Ser. No. 18/622,829, filed Mar. 29, 2024 and entitled “Automated Tool For Determining And Providing Information About Dwellings Within Geographical Regions That Are Determined Specific To Indicated Locations”; and in U.S. Non-Provisional patent application Ser. No. 18/632,217, filed Apr. 10, 2024 and entitled “Automated Tool For Determining And Providing Information About Dwellings Using Heterogenous Search Strategies”; each of which is incorporated herein by reference in its entirety.

For illustrative purposes, some embodiments are described herein in which specific types of information are acquired, used and/or presented in specific ways using specific types of data structures and by using specific types of devices—however, it will be understood that the described techniques may be used in other manners in other embodiments, and that the invention is not limited to exemplary details provided. As one non-exclusive example, specific types of data structures and algorithms are generated and/or used in specific manners in some embodiments, but it will be appreciated that other types of information may be generated and used in other manners in other embodiments, including for types of information other than dwelling information and for other types of predicted future user responses. Similarly, while particular user interface display and interaction techniques are shown, other user interaction techniques may be used in other embodiments. In addition, various details are provided in the drawings and text for exemplary purposes, but are not intended to limit the scope of the invention—for example, sizes and relative positions of elements in the drawings are not necessarily drawn to scale, with some details omitted and/or provided with greater prominence (e.g., via size and positioning) to enhance legibility and/or clarity, and identical reference numbers may be used in the drawings to identify the same or similar elements or acts.

FIG. 3 is a block diagram illustrating an embodiment of one or more server computing systems 300 executing an implementation of an ADSDM system 140, such as in a manner similar to that of FIGS. 1A-1C and 2A-2E and with additional hardware details illustrated—the server computing system(s) and ADSDM system may be implemented using a plurality of hardware components that form electronic circuits suitable for and configured to, when in combined operation, perform at least some of the techniques described herein. In the illustrated embodiment, each server computing system 300 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.).

The server computing system(s) 300 and executing ADSDM system 140 may communicate with other computing systems and devices via one or more networks 100 (e.g., the Internet, one or more cellular telephone networks, etc.), such as user client computing devices 360 (e.g., used to supply queries; receive responsive answers; and use the received answer information, such as to display or otherwise present answer information to users of the client computing devices and/or to implement further automated activities, such as to access other functionality provided by the ADSDM system), optionally other external devices 380 (e.g., used to store and provide dwelling-related and/or user-action-related information of one or more types), and optionally other computing systems 390.

In the illustrated embodiment, an embodiment of the ADSDM system 140 executes in memory 330 in order to perform at least some of the described techniques, such as by using the processor(s) 305 to execute software instructions of the system 140 in a manner that configures the processor(s) 305 and computing system 300 to perform automated operations that implement those described techniques. The illustrated embodiment of the ADSDM system may include one or more components, not shown, to each perform portions of the functionality of the ADSDM system, and the memory may further optionally execute one or more other programs 335. The ADSDM system 140 may further, during its operation, store and/or retrieve various types of data on storage 320 (e.g., in one or more databases or other data structures), such as various types of user data 328, dwelling data 321 (e.g., dwelling occupancy descriptions, dwelling attributes and associated values, etc.), dwelling occupancy description modification types data 327a, quantile data 327b, optionally region data 327c, one or more trained predictive models 151 (e.g., quantile random forest models) and/or various other types of optional additional information 329.

Some or all of the user client computing devices 360 (e.g., mobile devices), external devices 380, and other computing systems 390 may similarly include some or all of the same types of components illustrated for server computing system 300. As one non-limiting example, the computing devices 360 are each shown to include one or more hardware CPU(s) 361, I/O components 362, and memory and/or storage 369, with a browser and/or ADSDM client program 368 optionally executing in memory to interact with the ADSDM system 140 and present or otherwise use query responses 367a and/or push messages 367b that are received from the ADSDM system, such as in response to submitted user queries 366 or as otherwise initiated by the ADSDM system. While particular components are not illustrated for the other devices/systems 380 and 390, it will be appreciated that they may include similar and/or additional components.

It will also be appreciated that computing system 300 and the other systems and devices included within FIG. 3 are merely illustrative and are not intended to limit the scope of the present invention. The systems and/or devices may instead each include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, and various other consumer products that include appropriate communication capabilities. In addition, the functionality provided by the illustrated ADSDM system 140 may in some embodiments be distributed in various components, some of the described functionality of the ADSDM system 140 may not be provided, and/or other additional functionality may be provided.

It will also be appreciated that, while various items are illustrated as being stored in memory or on storage while being used, these items or portions of them may be transferred between memory and other storage devices, such as for purposes of execution, memory management, data integrity, etc. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the ADSDM system 140 executing on server computing systems 300) and/or data structures, such as by execution of software instructions of the one or more software programs and/or by storage of such software instructions and/or data structures, and such as to perform algorithms as described in the flow charts and other disclosure herein. Furthermore, in some embodiments, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

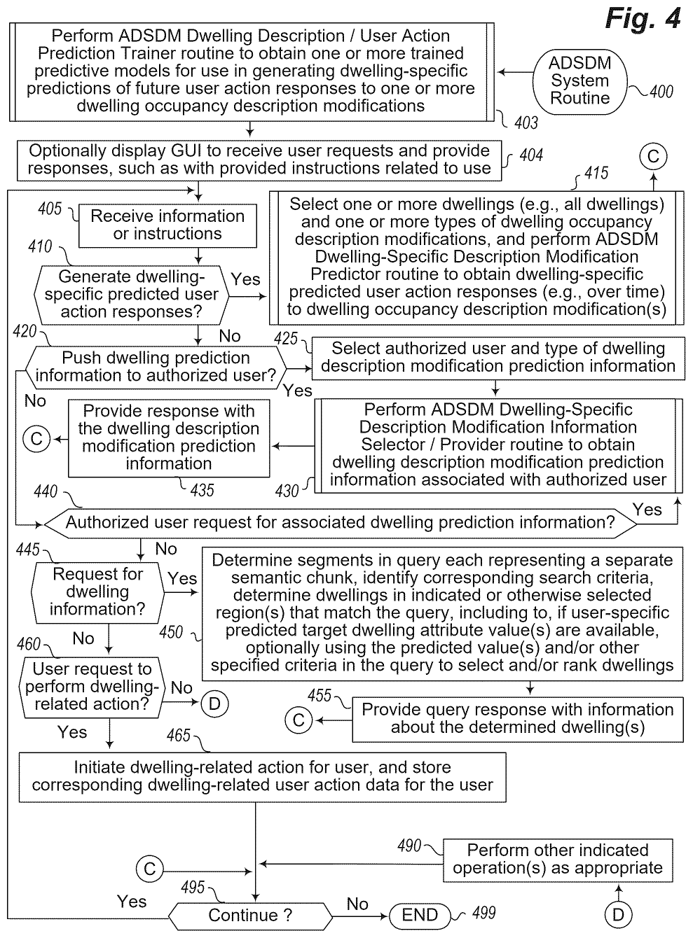

FIG. 4 is a flow diagram of an example embodiment of an ADSDM system routine 400. The routine may be provided by, for example, execution of the ADSDM system 140 of FIGS. 1A-1D, and/or the ADSDM system 140 of FIG. 3, and/or corresponding functionality discussed with respect to FIGS. 2A-2E and elsewhere herein, such as to perform automated operations related to automatically determining and using dwelling-specific predicted user responses to dwelling description information for a target dwelling. In the illustrated embodiment, the routine interacts with a single user at a time, such as to provide dwelling response information to search queries and other requests from that user and/or to provide push messages with proposed dwelling occupancy description modification data, but it will be appreciated that the routine may interact in a similar manner with multiple users (e.g., sequentially or concurrently), and that the routine may in other embodiments perform similar types of activities for other types of information.

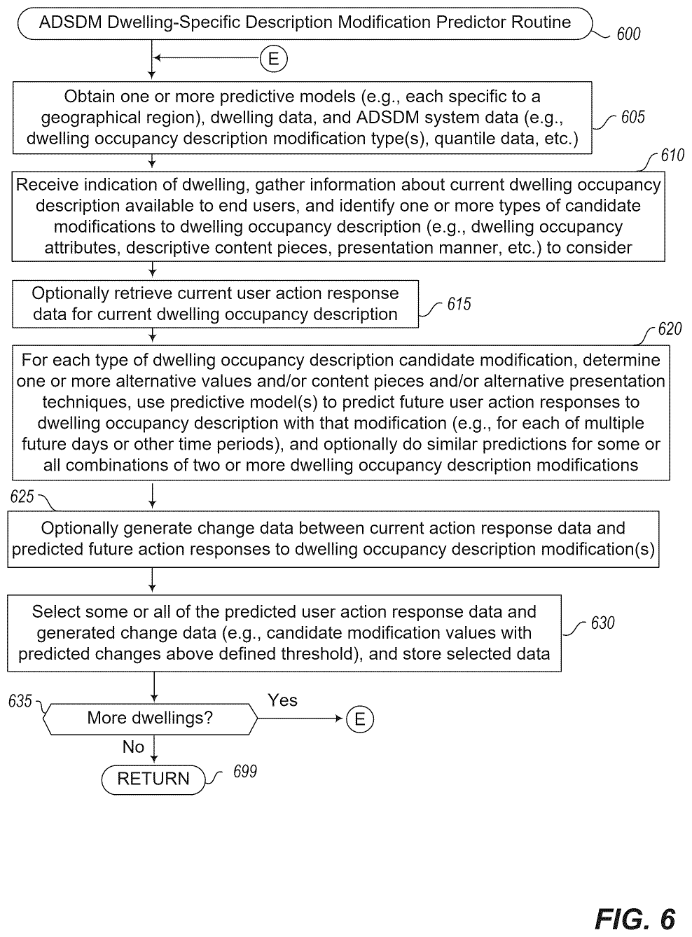

In the illustrated embodiment, the routine 400 begins at 403, where it performs the ADSDM Dwelling Description/User Action Prediction Trainer routine to generate and train one or more predictive models (e.g., quantile random forests models) for use in predicting values for one or more future user interactions values or other future user responses by end users who receive particular dwelling occupancy description information (e.g., including particular proposed dwelling occupancy description modifications), with one example of such a routine discussed further with respect to FIG. 5. The routine continues to block 404, where it optionally displays a GUI to a current user to receive user requests and/or provide dwelling-related information, and in 405 receives information or instructions, such as a request from the user via the GUI. In block 410, the routine determines whether the instructions or other information received in block 405 are to generate dwelling-specific predicted future user action responses, and if so continues to block 415, where it selects one or more dwellings (e.g., all available dwellings of an indicated type) and one or more types of dwelling occupancy description modifications (e.g., one or more predetermined types of modifications, one or more modification specific to a particular dwelling's dwelling occupancy description, etc.) and performs the ADSDM Dwelling-Specific Description Modification Predictor routine to obtain a corresponding dwelling-specific predicted future user action responses to the one or more types of dwelling occupancy description modifications, with one example of such a routine discussed further with respect to FIG. 6.

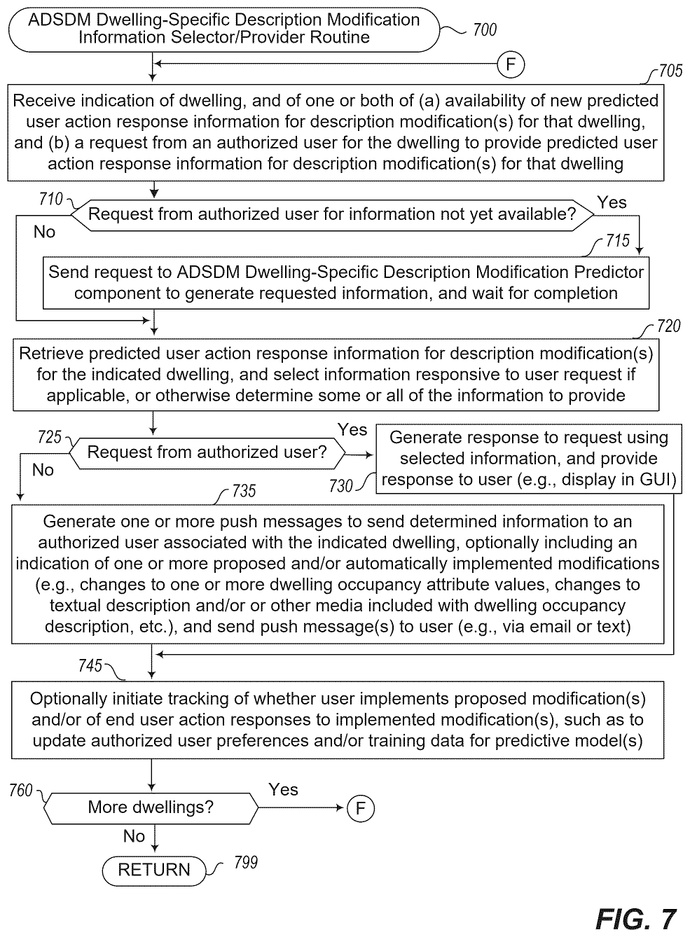

If it is instead determined in block 410 that the instructions or other information received in block 405 are not to generate dwelling-specific predicted future user action responses, the routine continues instead to block 420 to determine whether the instructions or other information received in block 405 are to push dwelling-specific predicted future user response information for one or more dwellings to one or more authorized users associated with the dwelling(s), and if so continues to block 425, where it selects at least one authorized user and at least one type of dwelling description modification for which to provide predict future user response information. After block 425, the routine continues to block 430, where it performs the ADSDM Dwelling-Specific Description Modification Information Selector/Provider routine to obtain the predicted future user response information for each combination of associated dwelling and selected type of dwelling description modification, with one example of such a routine discussed further with respect to FIG. 7. If it is instead determined in block 420 that the instructions or other information received in block 405 are not to push dwelling prediction information to an authorized user, the routine continues instead to block 440, where it determines if the instructions or other information received in block 405 correspond to a request from an authorized user for associated predicted future user response information for one or more dwellings with which the authorized user is associated, and if so continues to block 430 to perform the ADSDM Dwelling-Specific Description Modification Information Selector/Provider routine to obtain the requested predicted future user response information. After block 430, the routine continues to block 435, where it provides one or more push messages or other responses to the received request to the authorized user.

If it is instead determined in block 440 that the instructions or other information received in block 4052 not correspond to a request from an authorized user for associated patient information, the routine continues instead to block 445, where determines if the instructions or other information received in block 405 are a request from an end-user for dwelling information, and if so continues to block 450 to determine and provide corresponding information to the end-user. In this example, the operations in block 450 include receiving a search query in a natural language form, determining segments in the query each representing a separate semantic chunk, identifying corresponding search criteria, determining dwellings in indicated or otherwise selected geographical regions that match the query, including to, if user-specific search-related criteria are available, optionally further use such criteria to select and/or rank particular dwellings that are identified. In block 455, the routine then provides a query response with information about the determined dwellings.

It is instead determined in block 445 that the instructions or other information received in block 405 are not an end-user request for dwelling information, the routine continues to block 460 to determine if the instructions or other information received in 405 is an end-user request to perform a dwelling-related interaction, and if so continues to block 465 to initiate one or more indicated dwelling-related interactions for the end-user, and to store corresponding dwelling-related user interaction data for the end-user.

If it is instead determined in block 460 that the instructions or other information received in block 405 is not an end-user request to perform a dwelling-related interaction, the routine in block 490 proceeds to perform one or more other indicated operations as appropriate, with non-exclusive examples of such other operations including retrieving and providing previously determined or generated information (e.g., previous user queries, previously determined responses to user queries, previous push messages, etc.), receiving and storing information for later use (e.g., information about dwelling data 321, user data 328, ADSDM system data 327, etc.), responding to other types of search queries (e.g., using user-specified filters), receiving and using feedback from a user in response to provided information, providing information about how one or more previous query responses were determined, performing housekeeping operations, etc.

After blocks 415, 435, 455, 465 or 490, the routine continues to block 495 to determine whether to continue, such as until an explicit indication to terminate is received (or alternatively only if an explicit indication to continue is received). If it is determined to continue, the routine returns to block 405 to await further information or instructions from the same user, and if not continues to block 499 and ends.

FIG. 5 is a flow diagram of an example embodiment of an ADSDM Dwelling Description/User Action Prediction Trainer routine 500. The routine may be provided by, for example, execution of the ADSDM Dwelling Description/User Action Prediction Trainer component 141 of FIGS. 1A-1D and/or a corresponding component (not shown) of the ADSDM system 140 of FIG. 3 and/or with respect to corresponding functionality discussed with respect to FIGS. 2A-2E and elsewhere herein, such as to generate and train one or more predictive models 151 (e.g., quantile random forests models) for use in predicting values for one or more future user interactions values or other future user responses by end users who receive particular dwelling occupancy description information (e.g., having particular proposed dwelling occupancy description modifications). In addition, in at least some situations, the routine 500 may be performed based on execution of block 403 of FIG. 4, with resulting information provided and execution control returning to that location when the routine 500 ends—in other embodiments, the routine may be invoked in other manners. In this example, the routine 500 is performed using particular ways to generate particular types of predictive models (e.g., quantile random forest models), but in other embodiments may use other techniques to generate the same or other types of predictive models, whether in addition to or instead of the illustrated types of techniques.

The illustrated embodiment of the routine 500 begins at block 505, where data is obtained about user-dwelling interactions for a plurality of users (including final dwelling transactions to acquire and/or occupy particular dwellings, or other final selections), dwelling occupancy description data for the interacted-with dwellings, optionally user data for the users performing the interactions including various user characteristics, information about one or more dwelling occupancy description modification types for which to predict values for user action responses, quantile data to generate and provide for predictions, optionally regions for which to separately generate predictive models, etc. In block 510, the routine then groups information about one or more types of interactions of the end users with each dwelling (e.g., for a defined period of time and/or quantity of users, and optionally including one or more target dwelling attribute values for end users' selected final dwellings), and segments the users' interaction data by region if multiple regions are specified. In block 515, the routine then selects a next type of future user response for which to generate a predictive model, beginning with a first, and in block 520, selects a new geographical region and associated group of segmented user interaction data (if multiple geographical regions) or otherwise selects all user interaction data. In block 525, the routine then uses the selected user interaction data to generate and train a quantile random forest model (for the selected region if multiple regions, or otherwise overall) for the selected type of future user response, including modeling the entire conditional distribution for values of the selected type of future user response across the leaf nodes of the trees of the forest model in order to provide predictions at each of the multiple quantiles for that type of future user action responses, and using data about other dwelling attributes of the interacted-with dwellings for branching of the trees. In block 530, the routine then determines if there are more geographical regions, and if so returns to block 520 to select the next such region and associated segmented user interaction data for the currently selected type predicted user response, and otherwise continues to block 535 to determine if there are more types of predicted user responses. If so, the routine returns to block 515 to select the next type of predicted user response for which to generate a predictive model, and otherwise continues to block 595 to provide the one or more generated quantile random forest models trained to predict future user action responses for particular types of dwelling occupation description modifications (e.g., with multiple quantiles and optionally one or more associated confidence values). The routine then continues to block 599 and returns, such as to return to the flow of FIG. 4 at block 403 if invoked from there.

FIG. 6 is a flow diagram of an example embodiment of an ADSDM Dwelling-Specific Description Modification Predictor routine 600. The routine may be provided by, for example, execution of the ADSDM Dwelling-Specific Description Modification Predictor component 143 of FIGS. 1A-1D and/or a corresponding component (not shown) of the ADSDM system 140 of FIG. 3 and/or with respect to corresponding functionality discussed with respect to FIGS. 2A-2E and elsewhere herein, such as to use one or more predictive models to generate dwelling-specific predicted future user action responses (e.g., for each of multiple successive future periods of time) for each of one or more dwelling occupancy description modifications for one or more dwellings, such as in response to a request from an authorized user for corresponding information for one or more modifications for an associated dwelling, and/or proactively for each of one or more dwellings and associated dwelling occupancy description modifications that are automatically selected (e.g., for some or all dwellings available for each of one or more dwelling types and/or dwelling availability types, such as acquisition and/or occupancy, and one or more predetermined types of proposed dwelling occupancy description modifications). In addition, in at least some situations, the routine 600 may be performed based on execution of block 415 of FIG. 4, with resulting information provided and execution control returning to that location when the routine 600 ends—in other embodiments, the routine may be invoked in other manners. In this example, the routine 600 is performed using particular ways to generate dwelling-specific predicted future user action responses (e.g., using quantile random forest models), but in other embodiments may use other techniques to generate the same or other types of dwelling-specific predicted future user action responses, whether in addition to or instead of the illustrated types of techniques.

The illustrated embodiment of the routine 600 begins at block 605, where it obtains one or more predictive models (e.g., each specific to a geographical region and/or type of dwelling and/or type of dwelling availability), dwelling data about various dwellings in one or more geographical regions that are available for occupancy and/or acquisition (including dwelling occupancy descriptions for the dwellings), and one or more types of ADSDM system data (e.g., geographic regions; target types of dwelling occupancy description modifications to consider, such as for particular dwelling attributes; quantiles to use with quantile random forests and/or other predictive models; etc.). In block 610, the routine then receives an indication of a target dwelling (e.g., from a request from an associated authorized user, by selecting one of multiple available dwellings for which to generate predictions, etc.), gathers information about a current dwelling occupancy description (if any) available to end users for the dwelling, and identifies one or more types of candidate modifications to make with respect to the existing dwelling occupancy description (e.g., with respect to one or more target dwelling occupancy attributes, an overview textual narrative description, associated descriptive media items or other content pieces, a manner of presenting the dwelling occupancy description, etc.)—if a current dwelling occupancy description does not exist, the routine may instead perform operations to consider a variety of alternative values with respect to each type of candidate modification, such as for use in selecting a best group of associated attribute values and/or other dwelling occupancy description pieces of data as part of automatically generating a proposed new dwelling occupancy description. In block 615, the routine then optionally retrieves current user action response data for the current dwelling occupancy description (if any), such as to reflect a current dwelling occupancy description that has already been in use and presented to a variety of end-users but for which the associated dwelling has not yet had a completed transaction to occupy and/or acquire the dwelling. In block 620, the routine then, for each type of dwelling occupancy description candidate modification, determines one or more alternative values and/or content pieces to use for that modification (e.g., using an enumerated set of possible values for a particular dwelling attribute, using an enumerated list of types of media items for a dwelling occupancy description, using an enumerated list of types of details to include in an overview textual description, by determining variations for a current attribute value, etc.), and uses the one or more predictive models to predict future user action responses to a dwelling occupancy description that includes each such alternative value and/or content piece for that type of modification, including in at least some embodiments and situations to predict future quantities of user interactions or other types of future user action responses for each of multiple future days or other future periods of time. In at least some embodiments and situations, the routine may further generate such predicted future user action responses for combinations of two or more dwelling occupancy description modifications, such as for some or all combinations of possible values or content items or alternative text for each such dwelling occupancy description modification included in the combination (e.g., for all possible combinations of possible values or content items or alternative text for two or more dwelling occupancy description modifications,, for all combinations of two or more dwelling occupancy description modifications, etc.). In block 625, the routine then optionally generates change data to reflect differences between current user action response data (if available) and the predicted future user action response data, and in block 630 then selects some or all of the predicted user action response data and (if available) generated change data to retain and store as dwelling-specific predicted user action responses to description modifications (e.g., all predicted and generated data; predicted and generated change data for dwelling occupancy description candidate modifications having a highest predicted change from current action response data and/or otherwise having a highest predicted value for one or more target types of user action responses, such as highest predicted quantities of user interactions of one or more specified types; etc.), and optionally notifies the ADSDM Dwelling-Specific Description Modification Information Selector/Provider routine of the availability of the new dwelling-specific predicted user action responses to description modification data for use in optionally proactively sending some or all such new data to one or more corresponding authorized users associated with one or more dwellings to which the new data pertains. In block 635, the routine then determines if there are more dwellings for which to generate the predicted future user action responses, such as if an authorized user has requested such information for multiple associated dwellings or if the routine is proactively generating such data for multiple available dwellings, and if so returns to block 605 to perform similar processing for a next such indicated dwelling, and otherwise continues to block 699 and returns, such as to return to the flow of FIG. 4 at block 415 if invoked from there.

FIG. 7 is a flow diagram of an example embodiment of an ADSDM Dwelling-Specific Description Modification Information Selector/Provider routine 700. The routine may be provided by, for example, execution of the ADSDM Dwelling-Specific Description Modification Information Selector/Provider component 145 of FIGS. 1A-1D and/or a corresponding component (not shown) of the ADSDM system 140 of FIG. 3 and/or with respect to corresponding functionality discussed with respect to FIGS. 2A-2E and elsewhere herein, such as to retrieve dwelling description modification prediction information from generated dwelling-specific predicted future user action response data that is either responsive to a request received from an authorized user (or if the responsive information is not yet available, to initiate and wait for its generation), or to push dwelling description modification prediction information from new proactively generated dwelling-specific predicted future user action response data to one or more associated authorized users. In addition, in at least some situations, the routine 700 may be performed based on execution of block 430 of FIG. 4, with resulting information provided and execution control returning to that location when the routine 700 ends—in other embodiments, the routine may be invoked in other manners. In this example, the routine 700 is performed using particular ways to determine or select dwelling-specific predicted future user action responses, but in other embodiments may use other techniques to determine or select the same or other types of dwelling-specific predicted future user action response data, whether in addition to or instead of the illustrated types of techniques.

The illustrated embodiment of the routine 700 begins at block 705, where it obtains an indication of a dwelling from one or both of an authorized user request for predicted user action response information for that dwelling, or as an indication of availability of newly generated predicted user action response data for that dwelling (e.g., from the ADSDM Dwelling-Specific Description Modification Predictor routine), and in block 710 determines if the received indication corresponds to an authorized user request for information that is not yet available. If so, the routine in block 715 sends a corresponding request to the ADSDM Dwelling-Specific Description Modification Predictor routine to generate corresponding request information, and waits for completion before proceeding. After block 715, or if it is instead determined in block 710 that the indication of the dwelling is not part of an authorized user request for information that is not yet available, the routine in block 720 retrieves corresponding predicted user action response data for the indicated dwelling (e.g., all available predicted response data for the indicated dwelling; predicted response data with respect to one or more indicated candidate dwelling occupancy description modifications; etc.), and selects information responsive to the user request if applicable (e.g., for one or more indicated candidate dwelling occupancy description modifications), or otherwise determines some or all of the retrieved information to provide to an authorized user for the dwelling (e.g., all predicted response data, predicted response data for one or more candidate modifications having highest associated predicted user response data, etc.). In block 725, the routine then determines if the received indication of the dwelling was part of a request from an authorized user, and if so proceeds to block 730 to generate a response to the request using the information selected in block 720, and proceeds to provide corresponding responsive dwelling occupancy description modification prediction information to the authorized user (e.g., via a display of corresponding information in a GUI of the ADSDM system, or to otherwise respond to the request from the authorized user in a manner that it was received or as otherwise indicated by the authorized user). Otherwise, the routine proceeds to block 735 to generate one or more push messages to send corresponding responsive dwelling occupancy description modification prediction information determined in block 720 to an authorized user associated with the indicated dwelling, such as to optionally include information about one or more proposed and/or automatically implemented modifications to a dwelling occupancy description for the indicated dwelling, and sends the one or more push messages to the authorized user (e.g., via electronic communications sent via email or text). After blocks 730 or 735, the routine in block 745 optionally initiates tracking of whether the authorized user for the indicated dwelling implements proposed modifications provided to the authorized user (or cancels or reverts proposed modifications that were automatically implemented), such as to update user-specific information for the authorized user corresponding to preferences of the authorized user, and/or optionally initiates tracking of actual end user responses to implemented dwelling occupancy description modification(s), such as to track differences between predicted and actual user responses for use in updating training of the predictive model(s) in use. After block 745, the routine determines in block 760 if there are more dwellings for which to provide dwelling occupancy description modification prediction information, such as if an authorized user had requested such information for multiple associated dwellings or if the ADSDM Dwelling-Specific Description Modification Predictor routine indicated the availability of corresponding new predicted data for multiple available dwellings, and if so returns to block 705 to perform similar processing for a next such indicated dwelling, and otherwise returns in block 799, such as to return to the flow of FIG. 4 at block 430 if invoked from there.

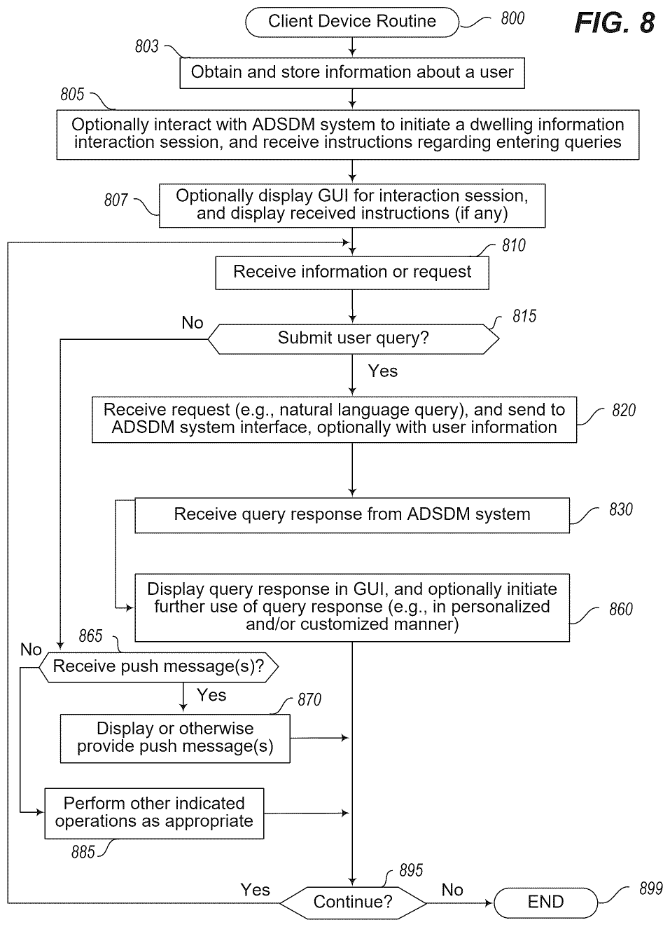

FIG. 8 is a flow diagram of an example embodiment of a client device routine 800. The routine may be provided by, for example, operations of a client computing device 360 of FIGS. 1A-1D and/or a client computing device 360 of FIG. 3 and/or with respect to corresponding functionality discussed with respect to FIGS. 2A-2E and elsewhere herein, such as to interact with users or other entities who submit queries (or other requests or information) to the ADSDM system, to receive responsive answers (or other information) from the ADSDM system, and to optionally use the received information in one or more manners (e.g., to automatically initiate follow-up activities in accordance with a received responsive answer or other received information).

The illustrated embodiment of the routine 800 begins at block 803, where information is optionally obtained and stored about the user, such as for later use in personalizing or otherwise customizing further actions to that user. The routine then continues to block 805 to optionally interact with the ADSDM system to initiate an interaction session (e.g., in response to a corresponding instruction from the user), as well as to optionally receive a greeting and/or introductory instructions regarding using a GUI of the ADSDM system, such as by displaying a GUI for the interaction session in block 807 in which the received greeting and/or introductory instructions (if any) are optionally displayed. The routine then continues to perform blocks 810-885 as part of participating in the interaction session or otherwise receiving push messages sent from the ADSDM system.

In particular, the routine continues to block 810 after block 807, where it waits until information or a request is received from the user. In block 815, the routine determines if the information or request received in block 810 is a request to submit, such as a search query in a natural language format (e.g., freeform text), and if not continues to block 865. Otherwise, the routine continues to block 820, where it sends the received query to the ADSDM system interface, optionally along with additional information about the user from block 803, to obtain a corresponding responsive answer—in other embodiments, the routine may further modify the received user query to personalize and/or customize the information to be provided to the ADSDM system (e.g., to add information specific to the user, such as location, demographic information, preference information, etc.). In block 830, the routine then receives a responsive answer to the query from the ADSDM system, and in block 860 displays the received query response in the GUI, and optionally initiates further use of the query response in one or more manners (e.g., in a manner that is personalized and/or customized for the user)—in some embodiments, the further initiated activities may include invoking of other functionality of the ADSDM system, such as to initiate an inspection process for a selected dwelling indicated in dwelling information search results, to initiate a mortgage application process for a selected dwelling indicated in dwelling information search results, to initiate matching the user with a real estate professional as part of a housing search based on corresponding response information received from the ADSDM system, etc.

In block 865, the routine determines if the information or request received in block 810 is one or more push electronic messages sent by the ADSDM system, and if so continues to block 870 to display or otherwise provide the received electronic messages to the user (e.g., stores the received electronic messages in a queue for later retrieval by the user)—in some embodiments and situations, such a displayed or otherwise provided electronic message may include one or more user-selectable controls that, if selected by the user, initiate further interactions with the ADSDM system or otherwise initiate further activities of one or more types. If it is instead determined in block 865 that the information or request received in block 810 is not one or more push electronic messages, the routine continues to block 885 to instead perform one or more other indicated operations as appropriate, with non-exclusive examples including sending information to the ADSDM system of other types (e.g., based on selections by the user of provided user-selectable controls), receiving and storing user data for later use in personalization and/or customization activities, receiving and responding to requests for information about previous user queries and/or corresponding responsive answers for a current user and/or client device, receiving and responding to indications of one or more housekeeping activities to perform, etc. After blocks 860, 870 or 885, the routine continues to block 895 to determine whether to continue, such as until an explicit indication to terminate is received (or alternatively only if an explicit indication to continue is received). If it is determined to continue, the routine returns to block 810, and if not continues to block 899 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the claims that are specified and the elements recited therein. In addition, while certain aspects of the invention may be presented at times in certain claim forms, the inventors contemplate the various aspects of the invention in any available claim form. For example, while only some aspects of the invention may be recited at a particular time as being embodied in a computer-readable medium, other aspects may likewise be so embodied.

1. A computer-implemented method comprising:
generating, by one or more computing devices and for first dwellings available for occupancy and each having an associated dwelling occupancy description with values for multiple first dwelling attributes, a trained predictive quantile random forest model to predict values of quantities for a plurality of quantiles of future selections of the first dwellings by first users in response to receiving associated dwelling occupancy descriptions for the first dwellings, including generating a plurality of decision trees that are part of the quantile random forest model and that are each associated with a respective one of the multiple first dwelling attributes, and further including using training data about a plurality of prior user selections by a plurality of second users of a plurality of second dwellings available for occupancy and having a plurality of dwelling attributes values in a plurality of dwelling occupancy descriptions for the plurality of second dwellings;
using, by the one or more computing devices, the trained quantile random forest model to predict, for a target first dwelling that is available for occupancy and that is separate from the plurality of second dwellings, predicted values, for the plurality of quantiles, of first selections of the target first dwelling by at least some of the first users, including:
obtaining, by the one or more computing devices, multiple current dwelling attribute values each associated with a respective one of multiple dwelling attributes of the target first dwelling;
determining, by the one or more computing devices, one or more candidate dwelling attribute value modifications each having, for one of the multiple dwelling attributes, a modified value for that dwelling attribute that is different from the current dwelling attribute value for that dwelling attribute;
supplying, by the one or more computing devices and as input to the trained quantile random forest model, the multiple current dwelling attribute values for the multiple dwelling attributes to obtain one or more first predicted values for one or more quantiles of the plurality of quantiles of future selections by the at least some first users of the target first dwelling in response to receiving the multiple current dwelling attribute values; and
supplying, by the one or more computing devices and as input to the trained quantile random forest model, at least the modified value for each of the one or more candidate dwelling attribute value modifications to obtain second predicted values for the one or more quantiles of future selections by the at least some first users of the target first dwelling in response to receiving at least the modified value for each of the one or more candidate dwelling attribute value modifications;
determining, by the one or more computing devices and based on changes between the first and second predicted values, at least one of the one or more candidate dwelling attribute value modifications to use with a first dwelling occupancy description for the target first dwelling;
presenting, by the one or more computing devices to one or more of the first users in one or more displayed graphical user interfaces (GUIs), the first dwelling occupancy description for the target first dwelling with the at least one candidate dwelling attribute value modification; and
tracking, by the one or more computing devices, actual further selections by the one or more first users of the target first dwelling in response to the presenting of the first dwelling occupancy description to the future users.

2. The computer-implemented method of claim 1 wherein the one or more candidate dwelling attribute value modifications include multiple candidate dwelling attribute value modifications, wherein the supplying of at least the modified value for each of the one or more candidate dwelling attribute value modifications as input to the trained quantile random forest model includes supplying a separate input for each of the multiple candidate dwelling attribute value modifications to the trained quantile random forest model and receiving at least one separate second predicted value for that separate input, and wherein the determining of the at least one candidate dwelling attribute value modification to use includes selecting one of the multiple candidate dwelling attribute value modifications whose separate second predicted value has a largest difference from the one or more first predicted values.

3. The computer-implemented method of claim 1 wherein obtaining of each of the first and second predicted values for the future selections of the target first dwelling includes obtaining a predicted range of values for each of multiple future days that represents at least one selected lower bound quantile and at least one selected upper bound quantile, wherein the first users are users searching for dwellings of at least one type that are available for occupancy, wherein the future selections by first users of the first dwellings include at least one of selecting information of a first dwelling for additional user review from search results that include indications of multiple dwellings, or requesting additional information about a first dwelling from an authorized user associated with that first dwelling, or saving a first dwelling for later review, or selecting a first dwelling for an in-person tour, and wherein the presenting of the first dwelling occupancy description to the one or more first users is performed as part of each of the one or more first users having selected information for the target first dwelling for additional user review from search results that include indications of multiple dwellings.

4. A computer-implemented method comprising:
generating, by one or more computing devices, a predictive quantile random forest model trained to predict values of quantities for a plurality of quantiles of future interactions of users with dwellings available for occupancy in response to providing the users with indicated dwelling attribute values for a plurality of dwelling attributes in dwelling occupancy descriptions for the dwellings, including generating a plurality of decision trees that are part of the quantile random forest model and that are each specific to a respective one of a selected group of dwelling attributes of the plurality of dwelling attributes, and further including using training data to populate values for each of the plurality of decision trees, wherein the training data is from a plurality of prior user interactions with a plurality of dwellings available for occupancy having values for the plurality of dwelling attributes in a plurality of dwelling occupancy descriptions for the plurality of dwellings;
using, by the one or more computing devices, the generated trained predictive quantile random forest model to predict, for each of multiple future periods of time, values of quantities for the plurality of quantiles of future interactions of first users with a target first dwelling available for occupancy, including:
obtaining, by the one or more computing devices, values for multiple current dwelling attributes of the target first dwelling;
determining, by the one or more computing devices, one or more candidate dwelling attribute value modifications to at least one dwelling attribute of the multiple current dwelling attributes; and
supplying, by the one or more computing devices and as input to the generated trained predictive quantile random forest model, the multiple current dwelling attribute values to obtain first predicted values of the quantities for the plurality of quantiles of future interactions of at least some of the first users with the target first dwelling for the multiple future periods of time based on those multiple current dwelling attribute values, and at least the one or more candidate dwelling attribute value modifications to obtain second predicted values of the quantities for the plurality of quantiles of future interactions of at least some of the first users with the target first dwelling for the multiple future periods of time based on the multiple current dwelling attribute values with the one or more candidate dwelling attribute value modifications;
determining, by the one or more computing devices and based on the first and second predicted values of the quantities for the plurality of quantiles of future interactions, at least one of the one or more candidate dwelling attribute value modifications to use with a first dwelling occupancy description for the target first dwelling; and
providing, by the one or more computing devices and to at least one user, information about the first dwelling occupancy description for the target first dwelling with the at least one candidate dwelling attribute value modification.

5. The computer-implemented method of claim 4 wherein obtaining of the first and second predicted values includes determining a lower bound of a predicted range of values that is a first selected quantile and determining an upper bound of the predicted range of values that is a second selected quantile.

6. The computer-implemented method of claim 5 wherein the at least one dwelling attribute for which the one or more candidate dwelling attribute value modifications are determined includes all of the multiple current dwelling attributes.

7. The computer-implemented method of claim 4 further comprising generating a stacked classifier model trained to predict values for each of one or more types of future interactions of users with dwellings available for occupancy for each of the multiple future periods of time using a survival curve analysis to provide increasing likelihoods of that type of future interaction for the target first dwelling occurring during each of the multiple future periods of time, and wherein predicting of one or more of the values of the quantities for the plurality of quantiles of future interactions of the first users with the target first dwelling for each of the multiple future periods of time further includes using the generated stacked classifier model.

8. The computer-implemented method of claim 4 wherein the generating of the predictive quantile random forest model includes generating multiple trained predictive quantile random forest models each specific to at least one of a geographical region or a type of dwelling or a type of future interaction, and wherein the supplying of the multiple current dwelling attribute values and of the at least of the one or more candidate dwelling attribute value modifications is performed to one of the multiple trained models that is selected based on information specific to the at least one of a geographical region of the target first dwelling or a type of dwelling of the target first dwelling or an indicated type of future interaction.

9. The computer-implemented method of claim 4 further comprising generating at least one of a generalized random forest that predicts at least a mean value for the quantity of future interactions of the first users with the target first dwelling available for occupancy, or an uplift random forest that predicts at least a change in the quantity of future interactions of the first users with the target first dwelling available for occupancy between the multiple current dwelling attribute values and the multiple current dwelling attribute values with the one or more candidate dwelling attribute value modifications, and wherein predicting of one or more of the values of the quantities for the plurality of quantiles of future interactions of the first users with the target first dwelling for each of the multiple future periods of time further includes using the generated at least one of the generalized random forest or the uplift random forest.

10. The computer-implemented method of claim 4 wherein the providing of the information to the at least one user about the first dwelling occupancy description for the target first dwelling with the at least one candidate dwelling attribute value modification includes providing the information to an authorized user associated with the target first dwelling and receiving a confirmation from the authorized user for use of the at least one candidate dwelling attribute value modification in the first dwelling occupancy description, and wherein the method further comprises, after the receiving of the confirmation from the authorized user:
providing the first dwelling occupancy description with the at least one candidate dwelling attribute value modification for the target first dwelling to at least some of the first users; and
tracking actual user responses of one or more types by the at least some first users in response to the providing of the first dwelling occupancy description with the at least one candidate dwelling attribute value modification to the at least some future users.

11. The computer-implemented method of claim 10 wherein the providing of the information to the authorized user about the first dwelling occupancy description for the target first dwelling with the at least one candidate dwelling attribute value modification is performed as at least one of a push message initiated by an automated dwelling-specific description modifier system being executed by the one or more computing devices, or a pull message initiated by a request from the authorized user.

12. The computer-implemented method of claim 4 wherein the using of the generated trained predictive quantile random forest model to predict the values of the quantities for the plurality of quantiles of future interactions of the first users with the target first dwelling for each of multiple future periods of time is performed after providing the first dwelling occupancy description for the target first dwelling without the at least one candidate dwelling attribute value modification to multiple second users and receiving actual prior interactions of at least some of the second users with the target first dwelling, and wherein the second predicted values of the quantities for the plurality of quantiles of future interactions of at least some of the first users with the target first dwelling for the multiple future periods of time represent predicted changes from one or more prior quantities of the actual prior interactions of the at least some of the second users.

13. The computer-implemented method of claim 4 wherein the at least one candidate dwelling attribute value modification includes multiple candidate dwelling attribute value modifications selected as providing a largest increase between respective first and second predicted values, wherein the using of the generated trained predictive quantile random forest model to predict the values of the quantities for the plurality of quantiles of future interactions of the first users with the target first dwelling for each of multiple future periods of time is performed to generate at least one of a proposed first dwelling occupancy description for the target first dwelling that includes at least some of the multiple candidate dwelling attribute value modifications, or to generate a plurality of alternative candidate dwelling attribute value modifications each having one or more respective second predicted values of the quantities for the plurality of quantiles of future interactions, and wherein the providing of the information to the at least one user about the first dwelling occupancy description for the target first dwelling with the at least one candidate dwelling attribute value modification includes providing the generated at least one of the proposed first dwelling occupancy description or the plurality of alternative candidate dwelling attribute value modifications to an authorized user associated with the target first dwelling for further use by the authorized user.

14. The computer-implemented method of claim 4 wherein the providing of the information to the at least one users includes transmitting, by the one or more computing devices, the information over one or more computer networks to each of at least one client device associated with the at least one users for display on the at least one client device, and wherein the generating of the predictive quantile random forest model is performed for dwellings that are available for at least one of rental or purchase.

15. A system comprising:
one or more hardware processors of one or more computing devices; and
one or more memories with stored instructions that, when executed by at least one of the one or more hardware processors, cause at least one computing device of the one or more computing devices to perform automated operations including at least:
generating a predictive quantile random forest model trained to predict, for a plurality of quantiles, future user responses to dwelling occupancy descriptions having a plurality of dwelling attributes for associated dwellings available for acquisition, including generating a plurality of decision trees that are part of the quantile random forest model and that are each associated with a respective one of at least some of the plurality of dwelling attributes, and further including using training data about a plurality of prior user interactions with a plurality of dwellings in response to receiving a plurality of dwelling occupancy descriptions for the plurality of dwellings;
using the trained predictive quantile random forest model to predict, for one or more quantiles of the plurality of quantiles, target future user responses of one or more types by first users for a target first dwelling available for acquisition, including:
determining one or more candidate modifications to a first dwelling occupancy description for the target first dwelling; and
supplying, as input to the trained predictive quantile random forest model, one or more candidate dwelling occupancy descriptions for the target first dwelling that include the one or more candidate modifications to obtain the predicted target future user responses of the one or more types by the first users for the one or more quantiles to the one or more candidate dwelling occupancy descriptions;
selecting, based on the predicted target future user responses, at least one of the one or more candidate modifications for use with a modified first dwelling occupancy description for the target first dwelling; and
providing information about the at least one candidate modification for use with the modified first dwelling occupancy description for the target first dwelling.

16. The system of claim 15 wherein the future interactions of the one or more types of the first users with the target first dwelling include at least one of selecting information of the target first dwelling for additional user review from search results that include indications of multiple dwellings, or requesting additional information about the target first dwelling from an authorized user associated with that first dwelling, or saving the target first dwelling for later review, or selecting the target first dwelling for an in-person tour.

17. The system of claim 15 wherein the predicted target future user responses for the one or more candidate dwelling occupancy descriptions include one or more predicted values for the target future user responses of the one or more types for each of multiple successive future periods of time using a survival curve analysis to provide increasing likelihoods of a target future user response for the target first dwelling occurring during each of the multiple successive future periods of time.

18. The system of claim 15 wherein the first dwelling occupancy description for the target first dwelling includes values for multiple current dwelling attributes of the plurality of dwelling attributes for the target first dwelling, wherein the determined one or more candidate modifications to the first dwelling occupancy description for the target first dwelling include one or more candidate modifications to the multiple current dwelling attribute values to be presented to the first users, wherein the supplying of the one or more candidate dwelling occupancy descriptions for the target first dwelling that include the one or more candidate modifications includes, for each of the one or more candidate dwelling occupancy descriptions, supplying as input the multiple current dwelling attribute values with at least one of the one or more candidate modifications to the multiple current dwelling attribute values, wherein the using of the trained predictive quantile random forest model to predict the target future user responses for the target first dwelling available for acquisition further includes supplying as input to the trained predictive quantile random forest model the multiple current dwelling attribute values without any of the determined one or more candidate modifications to obtain further predicted target future user responses of the one or more types by the first users to those multiple current dwelling attribute values, and wherein the selecting of the at least one candidate modification is based at least in part on a difference between the further predicted target future user responses and the predicted target future user responses for the at least one candidate modification.

19. The system of claim 15 wherein the first dwelling occupancy description for the target first dwelling includes one or more media items with content about the target first dwelling, and wherein the determined one or more candidate modifications to the first dwelling occupancy description for the target first dwelling include one or more changes to media items about the target first dwelling to be presented to the first users.

20. The system of claim 15 wherein the first dwelling occupancy description for the target first dwelling includes a textual description about the target first dwelling, and wherein the determined one or more candidate modifications to the first dwelling occupancy description for the target first dwelling include one or more changes to the textual description about the target first dwelling to be presented to the first users.

21. The system of claim 15 wherein the determined one or more candidate modifications to the first dwelling occupancy description for the target first dwelling include one or more changes to how the first dwelling occupancy description for the target first dwelling is to be presented to the first users.

22. The system of claim 15 wherein the providing of the information about the at least one candidate modification includes providing the information to an authorized user associated with the target first dwelling and receiving a confirmation from the authorized user for the use of the at least one candidate modification in the modified first dwelling occupancy description for the target first dwelling, and wherein the stored instructions include software instructions that, when executed by the at least one hardware processor, cause the at least one computing device to perform further automated operations including at least, after the receiving of the confirmation from the authorized user:
providing the modified first dwelling occupancy description for the target first dwelling to at least some of the first users; and
tracking actual user responses of the one or more types by the at least some first users in response to the providing of the modified first dwelling occupancy description to the at least some future users.

23. A non-transitory computer-readable medium having stored contents that cause one or more computing devices to perform automated operations, the automated operations including at least:
generating, by the one or more computing devices, a predictive quantile random forest model trained to predict, for a plurality of quantiles, future user responses to dwelling occupancy descriptions having indicated dwelling attribute values for associated buildings available for occupancy, including generating a plurality of decision trees that are part of the quantile random forest model and that are each associated with a respective one of at least some of the indicated dwelling attributes, and further including using training data about a plurality of prior user interactions with a plurality of buildings in response to receiving a plurality of dwelling occupancy descriptions having a plurality of dwelling attributes values for the plurality of buildings;
using, by the one or more computing devices, the trained predictive quantile random forest model to predict, for one or more quantiles of the plurality of quantiles, target future user responses of one or more types of first users with a target first building, including:
determining, by the one or more computing devices, one or more candidate modifications to a first dwelling occupancy description for the target first building; and
supplying, by the one or more computing devices and as input to the trained predictive quantile random forest model, one or more candidate dwelling occupancy descriptions for the target first building that include the one or more candidate modifications to obtain the predicted target future user responses of the one or more types by the first users for the one or more quantiles to the one or more candidate dwelling occupancy descriptions;
selecting, by the one or more computing devices and based on the predicted target future user responses, at least one of the one or more candidate modifications for use with a modified first dwelling occupancy description for the target first building; and
providing, by the one or more computing devices, information about the at least one candidate modification for use with the modified first dwelling occupancy description for the target first building.

24. The non-transitory computer-readable medium of claim 23 wherein the predicted target future user responses include predicted values for each of the one or more quantiles of quantities of future interactions of the one or more types of the first users with the target first building, and wherein the future interactions of the one or more types of the first users with the target first building include at least one of selecting information of the target first building for additional user review from search results that include indications of multiple buildings, or requesting additional information about the target first building from an authorized user associated with that target first building, or saving the target first building for later review, or selecting the target first building for an in-person tour.

25. The non-transitory computer-readable medium of claim 23 wherein the determined one or more candidate modifications to the first dwelling occupancy description for the target first building are for presentation to the first users and include at least one of one or more candidate modifications to multiple current dwelling attribute values for the target first building in the first dwelling occupancy description, or one or more changes to media items with content about the target first building in the first dwelling occupancy description, or one or more changes to a textual description about the target first building in the first dwelling occupancy description, or one or more changes to a manner in how the first dwelling occupancy description for the target first building is provided to the first users.
